(19) United States
(12) Patent Application Publication
(10) Pub. No.: US 2024/0119109 A1
(43) Pub. Date: Apr. 11, 2024

(54) METHODS AND SYSTEMS FOR TIME-AFFECTING LINEAR PATHWAY (TALP) EXTENSIONS

(71) Applicant: Kevin D. HOWARD, Mesa, AZ (US)

(72) Inventor: Kevin D. HOWARD, Mesa, AZ (US)

(21) Appl. No.: 18/367,996

(22) Filed: Sep. 13, 2023

Related U.S. Application Data
(60) Provisional application No. 63/406,205, filed on Sep. 13, 2022.

(51) Int. Cl. G06F 17/11

(52) U.S. Cl. CPC G06F 17/11

(57) ABSTRACT

Concepts of time-affecting linear pathways (TALPs) decomposed from existing application source code, algorithms, processes, software modules, and functions, are extended. For instance, T-polynomials can be expanded to define when the interaction of high-order polynomials can be treated as if they were linear functions using a new type of T-polynomial. The number of inherent analytics that are extractable from TALPs of an algorithm or source code can be expanded to include the prediction polynomials of advanced time complexity, advanced space complexity, resource complexity, and output complexity along with their inverses. An overlay to the TALP execution pathway is defined, allowing for input variable sensitivity analysis. Further, automatic detection and quantification of context variables are provided for more accurate sensor analysis.

### CROSS-REFERENCE TO RELATED APPLICATIONS

This Application claims priority to and the benefit of U.S. Provisional Patent Application No. 63/406,205, filed Sep. 13, 2022, which is fully incorporated herein by reference.

### TECHNICAL FIELD

The present invention relates generally to software decomposition and, more particularly, to extending the core concepts of time-affecting linear pathways (TALPs) decomposed from existing application source code, algorithms, processes, software modules, and functions.

### BACKGROUND OF THE INVENTION

U.S. Pat. No. 11,520,560 (Computer Processing and Outcome Prediction Systems and Methods), which is fully incorporated herein by reference, addresses the decomposition of existing application source code, algorithms, processes, software modules, and functions into executable and analyzable components called time-affecting linear pathways (TALPs).

Consider the general definition of an algorithm: any sequence of operations that can be simulated by a Turing-complete system. An algorithm can include multiple sequences of operations combined using conditional statements (if, switch, else, conditional operator, etc.) and organized as software units. As taught in U.S. Pat. No. 11,520,560, data transformation results, timings and time predictions are associated with a particular pathway through the unit, implying that there can be multiple such results associated with any unit. Since a unit can include multiple sequences of operations, the processing time of the unit is dependent on which sequence is selected and, thus, is temporally ambiguous—herein known as Turing's first temporal ambiguity (TFTA).

Next, consider a McCabe linearly-independent pathway (LIP). McCabe's LIP consists of linear sequences of operations, called code blocks, connected using conditional statements with known decisions. A LIP is a simple algorithm within the body of the complex algorithm. A code block within a LIP includes any non-conditional statement, including assignment statements, subroutine calls, or method calls, but not conditional loops. A LIP treats each conditional loop as creating a separate pathway, so changes in processing time due to changes in loop iterations cannot be tracked for the end-to-end processing time of the simple algorithm. Consider, however, that loops merely change the number of iterations of linear blocks of code, not the code blocks themselves, as the algorithm processes data end-to-end.

Since it is desirable to track changes in processing time for the end-to-end processing of an algorithm, and since changes in processing time are due to changes in the number of loop iterations (standard loops or recursion), the concept of a TALP includes loops as part of that pathway. That is, unlike a LIP, a TALP's code blocks can include one or more loops. By allowing loops as part of the same pathway, it is possible to show how time can vary for the end-to-end linear processing of each pathway in each software unit of an algorithm. Calculating the timing changes from a TALP's input attribute values on a per-TALP basis allows for the resolution of TFTA. It should be noted that an input attribute represents various physical attributes of a variable, not variable descriptions or metadata. These physical attributes can include variable type (integer, alpha-numeric, floating point, binary, etc.), variable dimensionality (scalar, 1-dimensional, 2-dimensional, etc.), variable dimension sizes (#x elements, #y elements, #z elements, etc.), variable input values, etc.

Loop structures may be constructed using one or more “for”, “do”, “while”, or “go to” statements, or from recursively called subroutines, functions, or methods. In programming there can also be hidden loops, called herein implied loops; for example, x^{y} can be thought of as Πᵢ₌₁^{y} x, a loop of y iterations with an initial value of i=1 and an ending condition of i>y. Other examples of implied loops are memory allocation functions like malloc or calloc and I/O functions such as read, write, scan, and scanf. If the y value is fixed then x^{y} (for example: x²) does not represent a hidden loop. The single loop or nested loops within a loop structure may include two different types of conditional statements: loop control and non-loop control. Loop-control conditional statements are part of a loop's starting, ending, or iteration condition, so they are treated as part of the loop structure itself, not as a true conditional statement. That is, loop-control conditional statements do not create additional TALPs even if they are distributed within the loop. Non-loop-control conditional statements are not part of a loop's starting, ending, or iteration condition and are treated the same as any other conditional statement. As such, each branch of the condition creates a separate TALP. Note that loops without input variable attributes, or any associated dependent variable attributes, that affect loop-control conditions generate non-varying or static processing time, in the same way that x^{y} with y fixed represents constant time.

Assignment statements are constants, variables, or arrays linked together using logical and/or mathematical operators and produce values for variables or array dimensions and elements. These linked code blocks are appended to the code block that calls them, effectively substituting the included code blocks for the subroutine, module and/or method calls. Note that code blocks that are not a part of a loop structure also generate non-varying or static processing time.

### SUMMARY OF THE INVENTION

Based on the time-affecting linear pathway (TALP)-related methods and technology described above, original concepts of computers and programming were analyzed to understand why simple questions have been so difficult to answer in computer science, questions such as: How long will it take to process an algorithm or software code, given some arbitrary but valid input dataset? How much faster will an algorithm or software code process data using n processing elements versus one processing element? How much memory will it take to process an algorithm or software code, given some arbitrary but valid input dataset? What code will activate in a software code, given some arbitrary but valid input dataset? How much electrical power will a software code consume, given some arbitrary but valid input dataset? What is the relationship between optimal cache and RAM memory allocation, given some arbitrary but valid input dataset? What is the sensitivity of an execution pathway to individual input variable values?

As discussed U.S. Pat. No. 11,520,560, executing a TALP while varying input variable attributes generates a time prediction polynomial that approximates the time complexity function that is an inherent analytic for the TALP. An inherent analytic predicts some aspect of the pathway's behavior, given some set of valid input variables for that pathway. TALPs are used herein to extend the TALP analytics and generate several new analytics.

Known non-linear curve-fitting methods that used table searches rather than calculations to build polynomials are expanded herein to include the first and second derivatives of each term, the automatic expansion of the search table itself based on maximum error calculations, and the retention of table-generated polynomials (herein called T-polynomials) for future use. The data points that the method can perform a curve fit on have been expanded from first quadrant ascending curves only to descending as well as ascending data points in any Cartesian graph quadrant. These T-polynomials are converted into prediction polynomials (analytics that predict execution pathway behavior) by unscaling and applying measurement units.

T-polynomials are expanded to base T-polynomials (the shape of a curve without size and position) that are used to define when the interaction of high-order polynomials can be treated as if they were linear functions as well as to define TALP surfaces and volumes. The number of inherent analytics that are extractable from the TALPs of an algorithm or source code is expanded to include advanced space complexity, resource complexity, and output complexity as well as new advanced time complexity curves, along with their inverses. An overlay to the TALP execution pathway is defined herein, output-affecting linear pathway (OALP), allowing for input variable sensitivity analysis and the generation of multi-variable T-polynomials from which the prediction polynomials are created. There is also a discussion of the automatic detection and quantification of context variables, and their dimensionality using TALP directed acyclic graphs (TALP DAGs), for more accurate sensor analysis.
1. Advanced time complexity—time prediction from temporal input variable attribute values, extended to include ascending and descending curves
   a. Advanced speedup—scaled advanced time complexity, predicted processing time performance multiplier from the number of processing elements
   b. Inverse advanced time complexity—predicted temporal input variable attribute values from time
   c. Inverse advanced speedup—predicted number of processing elements from the processing time performance multiplier
2. Type I, II, and III advanced space complexity—memory allocation prediction from input variable attribute values, including ascending and descending curves
   a. Freeup—scaled advanced space complexity, predicted memory allocation divisor given the number of processing elements
   b. Inverse advanced space complexity—predicted input variable attribute values from memory allocation
   c. Inverse freeup—predicted number of processing elements from the memory allocation divisor
3. Resource complexity—an extension of space complexity that predicts the allocation of non-memory hardware for an algorithm (e.g., display screens, communication channels, etc.)
4. Output complexity—output variable attribute value predictions from input variable attribute values that affect output
   a. Divvyup—scaled output complexity, predicted output value divisor given the number of processing elements
   b. Inverse output complexity—predicted input variable attribute values from computed ouput values
   c. Inverse divvyup—predicted number of processing elements from the output value divisor

Aspects, methods, processes, systems and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 depicts four graphs depicting position-time, data value-time, time-position, and time-data value, in accordance with embodiments of the present invention.

FIG. 2 depicts the decomposition of a time-affecting linear pathway (TALP) into multiple output-affecting linear pathways (OALPs), in accordance with embodiments of the present invention.

FIG. 3 depicts the decomposition of an algorithm or software code first into TALPs and then each TALP into OALPs, in accordance with embodiments of the present invention.

FIG. 4 depicts two graphs: T-polynomial and an inverse T-polynomial. The domains and ranges are shown as graph quadrants, in accordance with embodiments of the present invention.

FIG. 5 shows a graph depicting examples of a single curve with both monotonically ascending and monotonically descending components, all within the same graph quadrant, in accordance with embodiments of the present invention.

FIG. 6 shows a graph depicting a single monotonically ascending curve traversing first quadrant 2 and then quadrant 1, in accordance with embodiments of the present invention.

FIG. 7 shows a graph depicting a single curve that simultaneously traverses quadrant 2 to quadrant 1 and quadrant 3 to quadrant 4, in accordance with embodiments of the present invention.

FIG. 8 shows a graph depicting three sets of two TALP-based interacting, ascending and descending TALP line segments, in accordance with embodiments of the present invention.

FIG. 9 shows a graph depicting four sets of two TALP-based interacting ascending/ascending or descending/descending TALP line segments, in accordance with embodiments of the present invention.

FIG. 10 shows two graphs depicting an example of a TALP line segment-based surface and an example of a TALP line segment-based volume, in accordance with embodiments of the present invention.

FIG. 11 depicts a graph with an example of repeating TALP line segments defining a looping structure, in accordance with embodiments of the present invention.

FIG. 12 depicts a graph with an example of TALP-vector addition and subtraction, in accordance with embodiments of the present invention.

FIG. 13 shows two tables depicting examples of ascending and descending source values table searches in quadrant 1, generating the scaled T-polynomial, in accordance with embodiments of the present invention.

FIG. 14 depicts a target values table extended to enable the generation of first and second derivative T-polynomials simultaneous to the generation of standard T-polynomials, in accordance with embodiments of the present invention.

FIG. 15 depicts an example of the conversion of an algorithm's input and associated output variable attribute values into source value table format for automatic polynomial generation, that is, the conversion of a TALP's data transformation into a prediction polynomial, in accordance with embodiments of the present invention.

FIG. 16 depicts a continuation of input to output variable attributes showing when and how to shift source values, in accordance with embodiments of the present invention.

FIG. 17 depicts multiple, interacting tables used in an example of the generation of a T-polynomial, in accordance with embodiments of the present invention.

FIG. 18 depicts multiple tables comparing the use of a standard binary search method to the newly defined advanced binary search method when generating T-polynomials, in accordance with embodiments of the present invention.

FIG. 19 depicts a table definition used to store T-polynomials that are associated with TALPs, in accordance with embodiments of the present invention.

FIG. 20 shows a graph depicting a non-monotonic curve formed from averaging input and output values and representable as a set of multiple, linked, smaller monotonic curves, in accordance with embodiments of the present invention.

FIG. 21 depicts a set of tables depicting the association of monotonic direction (ascending or descending) with the generation of T-polynomial terms for time complexity, in accordance with embodiments of the present invention.

FIG. 22 shows a set of tables depicting the association of monotonic direction (ascending or descending) with the generation of T-polynomial terms for space complexity, in accordance with embodiments of the present invention.

FIG. 23 shows a workflow depicting the type I, II, and III advanced space complexity generation, in accordance with embodiments of the present invention.

FIG. 24 shows a workflow depicting multiple linked TALPs that do not share memory; that is, memory allocation resets for each TALP, in accordance with embodiments of the present invention.

FIG. 25 shows a workflow depicting multiple linked TALPs that share memory; that is, memory allocation does not reset for each TALP, in accordance with embodiments of the present invention.

FIG. 26 shows a set of tables depicting the creation of either a TALP or an OALP output prediction T-polynomial with monotonic direction (either ascending or descending), in accordance with embodiments of the present invention.

FIG. 27 depicts a set of tables used to generate and combine two single-variable source values tables, in accordance with embodiments of the present invention.

FIG. 28 depicts a graph of two linked TALPs where the first TALP has an ending time that must precede the starting time of the second TALP and where the ending and starting times are separated by some intervening time called slack time, in accordance with embodiments of the present invention.

FIG. 29 depicts a table highlighting the minimum and maximum columns in the target values table, in accordance with embodiments of the present invention.

FIG. 30 depicts a table that shows how to add a new maximum column to the target values table, in accordance with embodiments of the present invention.

FIG. 31 depicts a table that shows how to add a new minimum column to the target values table, in accordance with embodiments of the present invention.

FIG. 32 depicts a table that shows a multi-term T-polynomial in the target values table, in accordance with embodiments of the present invention.

FIG. 33 depicts a table that shows multi-term T-polynomials in a new multi-term target values table, in accordance with embodiments of the present invention.

FIG. 34 depicts a diagram comparing the output complexity of sensor detection with and without constant context effects, in accordance with embodiments of the present invention.

FIG. 35 depicts a diagram comparing the output complexity of sensor detection patterns with and without variable context effects, in accordance with embodiments of the present invention.

FIG. 36 depicts a diagram of detected interacting and non-Interacting context variables, in accordance with embodiments of the present invention.

FIG. 37 depicts a diagram of context variables with hidden dimensions or variables, in accordance with embodiments of the present invention.

FIG. 38 depicts a diagram of TALP directed acyclic graphs from additively linked context variables, in accordance with embodiments of the present invention.

FIG. 39 depicts a graph of multi-dimensional sensor detection output complexity with context, in accordance with embodiments of the present invention.

### DETAILED DESCRIPTION OF PREFERRED EMBODIMENTS

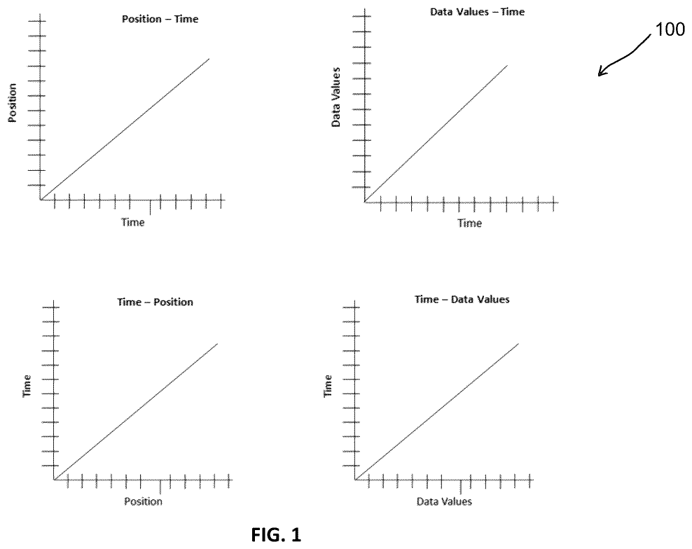

Referring generally to FIGS. 1-39, exemplary aspects of computing systems and methods for time-affecting linear pathway (TALP) extensions are provided.

Various devices or computing systems can be included and adapted to process and carry out the aspects, computations, and algorithmic processing of the software systems and methods of the present invention. Computing systems and devices of the present invention may include a processor, which may include one or more microprocessors, and/or processing cores, and/or circuits, such as an application specific integrated circuit (ASIC), field-programmable gate arrays (FPGAs), etc. Further, the devices can include a network interface. The network interface is configured to enable communication with a communication network, other devices and systems, and servers, using a wired and/or wireless connection.

The devices or computing systems may include memory, such as non-transitive, which may include one or more non-volatile storage devices and/or one or more volatile storage devices (e.g., random access memory (RAM). In instances where the computing devices include a microprocessor, computer readable program code may be store3d in a computer readable medium or memory, such as, but not limited to drive media (e.g., a hard disk or SSD), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The devices or computing devices may include an input device. The input devices is configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, etc. The devices can also include an output device. Examples of output devices include monitors, televisions, mobile device screens, tablet screens, speakers, remote screens, etc. The output devices can be configured to display images, media files, text, video, or play audio to a user through speaker output.

Server processing systems for use or connected with the systems of the present invention, can include one or more microprocessors, and/or one or more circuits, such as an application specific in ASIC, FPGAs, etc. A network interface can be configured to enable communication with a communication network, using a wired and/or wireless connection, including communication with devices or computing devices disclosed herein. Memory can include one or more non-volatile storage devices and/or one or more volatile storage devices (e.g., RAM). In instances where the server system includes a microprocessor, computer readable program code may be stored in a computer readable medium, such as, but not limited to drive media (e.g., a hard disk or SSD), optical media (e.g., a DVD), memory devices etc.

Referring to graph 100 of FIG. 1, typically, the execution of code, including the code blocks of a TALP, can be timed. This means that the input values used by the code during its execution and the processing time of that execution are easily known. Those input values are both non-temporal and temporal input variable attribute values. Non-temporal input variable attribute values do not cause processing time to vary. Temporal input variable attribute values cause processing time to vary by affecting the loop iterations of the code. In the graphs here, the input data values affect the loop iterations of the code, regardless of whether data is used in a calculation (changes input value without movement in an array) or being moved to a new position in an array or a combination of both. A position input/time or time/position input graph shows the position of an object (or a data value in an array) in relation to time and an analogous non-position input/time or time/non-position input graph shows how many input data values are processed in relation to time.

Given an input time value, a time-position prediction polynomial would calculate an output position value. Analogously, given an input time value, a time-temporal input data value prediction polynomial would calculate the temporal output data values. The inverse of the time-position graph is the position-time graph, and the inverse of the time-temporal input data values graph is the temporal input data values-time graph. Given a temporal input data value, a position-time prediction polynomial would calculate time and an input data value-time prediction polynomial would also calculate time. It should be noted that advanced time complexity is defined as the change in time from the change in input variable attribute values that affect loop iterations.

### OALP Definition

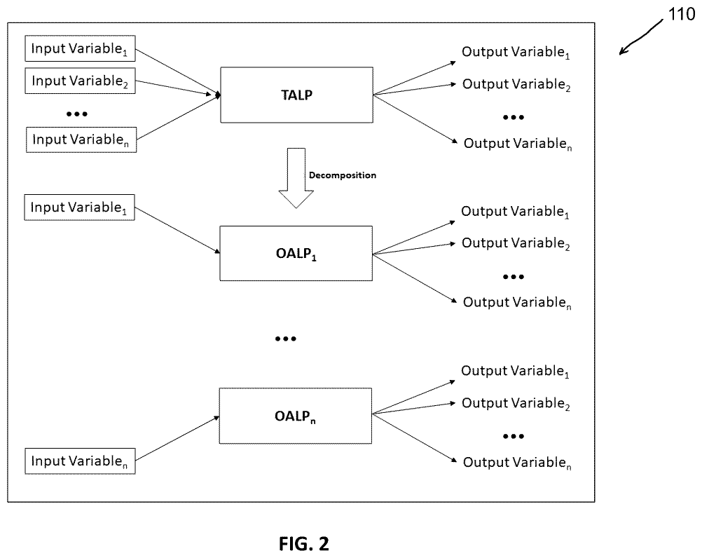

FIG. 2 shows a diagram 110 of a TALP decomposed into multiple output-affecting linear pathways (OALPs), each with a single input variable attribute and one or more output variable attributes. An output-affecting linear pathway, OALP, is a TALP with only one of its inputs acting as a variable and the other inputs held constant. Multiple OALPs, one per input, can be thought of as overlying the same TALP. Sensitivity is the effect of an input variable value on the set of output variable values and can be determined by varying a single input variable value at a time while holding all other input variable values constant. Calculating the sensitivity of an algorithm to its input variables means comparing the effects of the impact of each input variable on the output and is used to determine which input variable is most important to the algorithm. Since a TALP is the execution pathway of an algorithm or source code, this means the sensitivity of a TALP to its input variables.

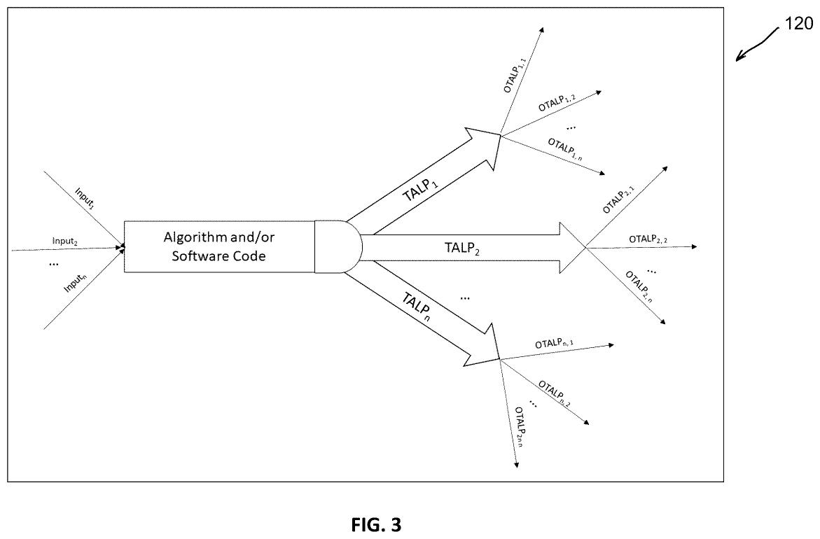

Referring to diagram 120 of FIG. 3, the set of OALPs for a TALP represents a set of irreducible overlaid pathways. Thus, existing application source code, algorithms, processes, software modules, and functions can be decomposed into TALPs, and each TALP with multiple input and output variables can be further decomposed into a set of irreducible overlaid pathways, OALPs.

Consider that a TALP that has multiple input variables consists of one or more OALPs. Since a TALP can be selected based on some set of input variable attributes, an OALP for that TALP can be selected by identifying the required input variable.

### Prediction Polynomials and T-Polynomial Definition

In various embodiments, only monotonic prediction polynomials with integer coefficients and integer powers were considered. In the present invention, any set of additively linked terms consisting of either a real-valued coefficient of a variable with a positive real-valued power (herein called a real-valued polynomial term, f(c, x, k)) or a real-valued coefficient multiplying the log with a real-valued base of a variable (herein called an inverse real-valued polynomial term, f⁻¹(c, x, k)), whose cumulative value is monotonic, is considered.

Prediction polynomials consist of real-valued polynomial terms as shown in Equation 1 and Equation 2. These prediction polynomials are formed from some predictable aspect of an algorithm; that is, each represents an inherent analytic for the algorithm.

f(c,x,k)=cx^{k} Equation 1 Positive Real-Valued Polynomial Term Definition
Where c=a real-valued constant
k=a real-valued power

f⁻¹(c,x,k)=c logₖx Equation 2 Positive Inverse Real-Valued Polynomial Term Definition
Where c=a real-valued constant
x=a real-valued input variable

Polynomials consisting of these real-valued terms are known as prediction polynomials, [symbol] (x), when x is not scaled and as T-polynomials,

$$T ( \frac{x}{{x}_{min}} ) ,$$

when x is scaled. A TALP-associated or OALP-associated additively combined set of monotonic f(c, x, k) or f⁻¹(c, x, k) terms is given as:

y= [symbol] (x)=(f₁(c₁, x₁, k₁) or f₁⁻¹(c₁, x₁, k₁))+(f₂(c₂, x₂, k₂) or f₂⁻¹(c₂, x₂, k₂))+ . . . +(fₙ(cₙ, xₙ, kₙ) or fₙ⁻¹ (cₙ, xₙ, kₙ)) Equation 3 Prediction Polynomial

If the x values are scaled by its smallest value, xₘᵢₙ, Equation 3 is rewritten into scaled form:

$$\frac{y}{{y}_{min}} = T ( \frac{x}{{x}_{min}} ) = ( {f}_{1} ( {c}_{1} , \frac{{x}_{1}}{{x}_{min}} , {k}_{1} ) or \\ {f}_{1}^{- 1} ( {c}_{1} , \frac{{x}_{1}}{{x}_{min}} , {k}_{1} ) ) + ( {f}_{2} ( {c}_{2} , \frac{{x}_{2}}{{x}_{min}} , {k}_{2} ) or \\ {f}_{2}^{- 1} ( {c}_{2} , \frac{{x}_{2}}{{x}_{min}} , {k}_{2} ) ) + … + ( {f}_{n} ( {c}_{n} , \frac{{x}_{n}}{{x}_{min}} , {k}_{n} ) or \\ {f}_{2}^{- 1} ( {c}_{n} , \frac{{x}_{n}}{{x}_{min}} , {k}_{n} ) ) \\ Scaled Prediction Polynomial , T - Polynomial \qquad Equation 4$$

The values of the input and output variables of these polynomials can be plotted on graphs and form curves. Curves in general do not have to be monotonic, but the methods herein of generating polynomials require that curves or curve segments be monotonic. As long as the non-monotonic curve is continuous and differentiable, it can be decomposed into multiple monotonic curve segments. For finite graphs, there is always a minimum and maximum value for each monotonic curve segment that originates from the decomposition of a finite, continuous, non-monotonic curve.

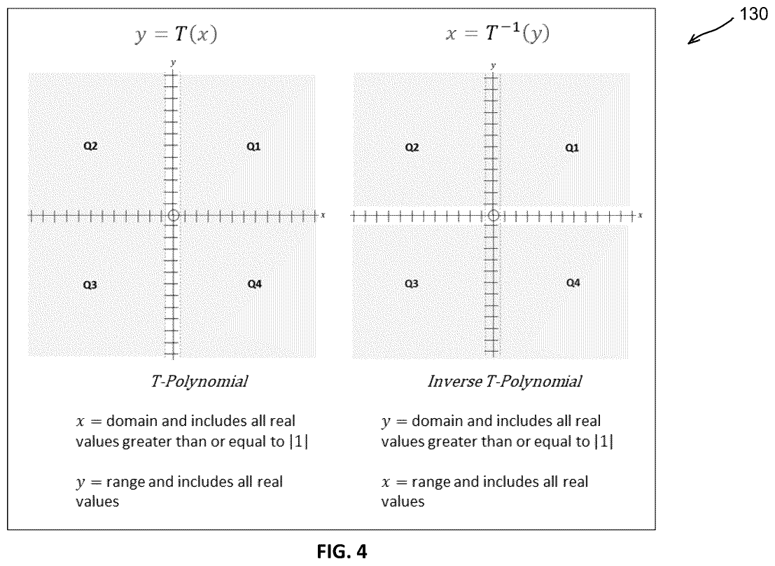

Referring to graph 130 of FIG. 4, the method of constructing a T-polynomial shown herein uses a finite table of values, which requires that the input values used by the table be limited in some way. Consider that any finite set of monotonic input values with an associated monotonic set of output values has a minimum and a maximum value for both the inputs and the outputs. Consider also that it is possible to use the minimum values as scaling factors. Scaling the values by their smallest detected value limits the table size to a manageable number of entries. However, this means that the smallest value cannot be zero. The domain and range of the T-polynomial are given.

It now becomes possible to generate a T-polynomial from the set of input and output values. Multiplying the results of the T-polynomial by the smallest value detected when constructing the T-polynomial (unscaling) yields the actual desired values, converting the T-polynomial into a prediction polynomial, which is an analytic automatically generated from data extracted from a TALP or OALP and associated with that TALP or OALP. The following equations for prediction polynomials in the first form assume the associated TALP or OALP is executing on a single processing element. In quadrant 1, the input variable value is positive and the output value is positive.

$$Quadrant 1 , Prediction Polynomial , First Form$$

$$y \times units = ( {x}_{1} ) = T ( \frac{{x}_{1}}{{x}_{min}} ) \times {y}_{min} \times units ⇔ {x}_{min} \neq 0 \qquad Equation 5$$

$$Where ( {x}_{1} ) = prediction polynomial$$

$$T ( \frac{{x}_{1}}{{x}_{min}} ) = T - polynomial$$

$$\frac{{x}_{1}}{{x}_{min}} = scaled input value for T \text{-polynomial}$$

x₁=input attribute value on a single processing element
yₘᵢₙ=scale factor, the minimum value used to generate the T-polynomial
units=the measurement units (seconds, megabytes, giga-attribute values, etc.)

The same prediction polynomial in quadrant 2 is detectable when the input variable value is negative and output is positive. The same prediction polynomial in quadrant 3 is detectable when the input variable value is negative and the output is also negative, and in quadrant 4 when the input variable value is positive and the output is negative.

$$Quadrant 2 , Prediction Polynomial , First Form$$

$$y \times units = ( - {x}_{1} ) = T ( \frac{\vert - {x}_{1} \vert}{{x}_{min}} ) \times {y}_{min} \times units \qquad Equation 6$$

$$Quadrant 3 , Prediction Polynomial , First Form$$

$$- y \times units = ( - {x}_{1} ) = - T ( \frac{\vert - {x}_{1} \vert}{{x}_{min}} ) \times {y}_{min} \times units \qquad Equation 7$$

$$Quadrant 4 , Prediction Polynomial , First Form$$

$$- y \times units = ( {x}_{1} ) = - T ( \frac{{x}_{1}}{{x}_{min}} ) \times {y}_{min} \times units \qquad Equation 8$$

The prediction polynomials can have a second form, herein called the standard form. The slight modification to the first form allows for the generation of polynomials from both ascending and descending curves. Because the monotonic curve segments discussed herein are finite, the standard form for ascending prediction polynomials must have a starting and ending input value. For ascending prediction polynomials, the starting input attribute value is xₘᵢₙ and the ending input attribute value is xₘₐₓ. As with the prediction polynomial first form, xₘᵢₙ cannot be zero. The following equations for prediction polynomials in the standard form assume the associated TALP or OALP is executing on a single processing element. In quadrant 1, the input variable value is positive and the output value is positive.

$$Quadrant 1 , Ascending Prediction Polynomial , Standard Form$$

$$y \times units = {}_{{Q}_{1}} ( {}^{↑} {x}_{1} ) = ( T ( \frac{{x}_{1}}{{x}_{min}} ) \times {y}_{min} ) \times units ⇔ ( {x}_{min} \neq 0 , {x}_{1} \geq {x}_{min} \& {x}_{1} \leq {x}_{max} ) \qquad Equation 9$$

$$Where {}_{{Q}_{1}} ( {}^{↑} {x}_{1} ) = quandrant 1 , ascending prediction polynomial$$

$$T ( \frac{{x}_{1}}{{x}_{min}} ) = ascending , T - polynomial$$

The same prediction polynomial in quadrant 2 is detectable when the input variable value is negative and output is positive. The same prediction polynomial in quadrant 3 is detectable when the input variable value is negative and the output is also negative, and in quadrant 4 when the input variable value is positive and the output is negative.

$$Quadrant 2 , Ascending Prediction Polynomial , Standard Form$$

$$y \times units = {}_{{Q}_{2}} ( {-}^{↑} {x}_{1} ) = T ( \frac{\vert - {x}_{1} \vert}{{x}_{min}} ) \times {y}_{min} \times units \qquad Equation 10$$

$$Quadrant 3 , Ascending Prediction Polynomial , Standard Form$$

$$- y \times units = {}_{{Q}_{3}} ( {-}^{↑} {x}_{1} ) = - T ( \frac{\vert - {x}_{1} \vert}{{x}_{min}} ) \times {y}_{min} \times units \qquad Equation 11$$

$$Quadrant 4 , Ascending Prediction Polynomial , Standard Form$$

$$- y \times units = {}_{{Q}_{4}} ( {}^{↑} {x}_{1} ) = - T ( \frac{{x}_{1}}{{x}_{min}} ) \times {y}_{min} \times units \qquad Equation 12$$

To achieve the descending affect, the input value must be manipulated, as shown in the equations below:

$$Quadrant 1 , Descending Prediction Polynomial , Standard Form$$

$$y \times units = {}_{{Q}_{1}} ( {}^{↓} {x}_{1} ) = \frac{T ( {x}_{max} )}{T ( \frac{{x}_{1}}{{x}_{min}} )} \times {y}_{min} \times units ⇔ ( T ( \frac{{x}_{1}}{{x}_{min}} ) \neq 0 , {}^{↓} {x}_{1} \geq {x}_{min} \& T ( \frac{{x}_{1}}{{x}_{min}} ) \leq {x}_{max} ) \qquad Equation 13$$

$$Where {}_{{Q}_{1}} ( {}^{↓} {x}_{1} ) = quadrant 1 , descending prediction polynomial$$

$$Quadrant 2 , Descending Prediction Polynomial , Standard Form$$

$$y \times units = {}_{{Q}_{2}} ( {-}^{↓} {x}_{1} ) = \frac{T ( {x}_{max} )}{T ( \frac{\vert - {x}_{1} \vert}{{x}_{min}} )} \times {y}_{min} \times units \qquad Equation 14$$

$$Quadrant 3 , Descending Prediction Polynomial , Standard Form$$

$$- y \times units = {}_{{Q}_{3}} ( {-}^{↓} {x}_{1} ) = - \frac{T ( {x}_{max} )}{T ( \frac{\vert - {x}_{1} \vert}{{x}_{min}} )} \times {y}_{min} \times units \qquad Equation 15$$

$$Quadrant 4 , Descending Prediction Polynomial , Standard Form$$

$$- y \times units = {}_{{Q}_{4}} ( {}^{↓} {x}_{1} ) = - \frac{T ( {x}_{max} )}{T ( \frac{{x}_{1}}{{x}_{min}} )} \times {y}_{min} \times units \qquad Equation 16$$

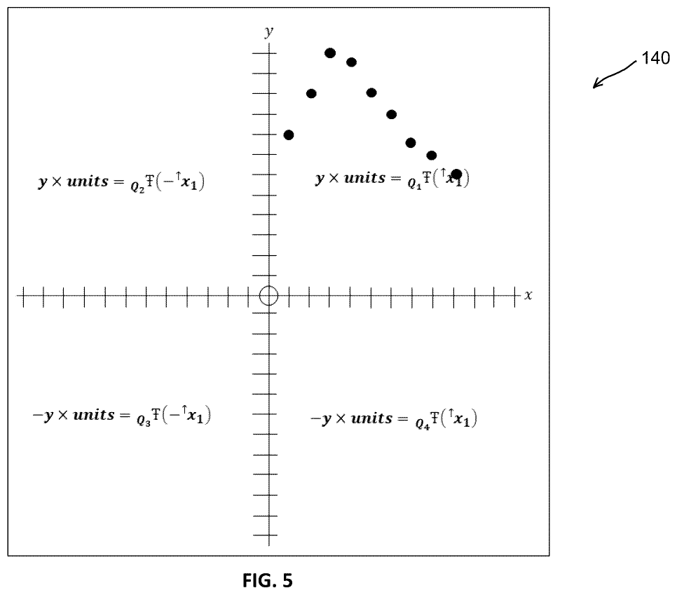

FIG. 5 shows, in graph 140, that if a curve transitions from monotonically ascending to monotonically descending, then it decomposes into curve segments whose un-scaled data points are used to generate two linked prediction polynomials within a quadrant. These equations represent the two linked prediction polynomials.

f(⁵⁵⁶ x₁)=_{Q}_{₂} [symbol] ₁(^{⬆}x₁)⇔x₁≥1 & x₁≤3 and

f(^{⬇}x₁)=_{Q}_{₁} [symbol] ₂(^{⬇}x₁)⇔x₁≥3 & x₁≤9

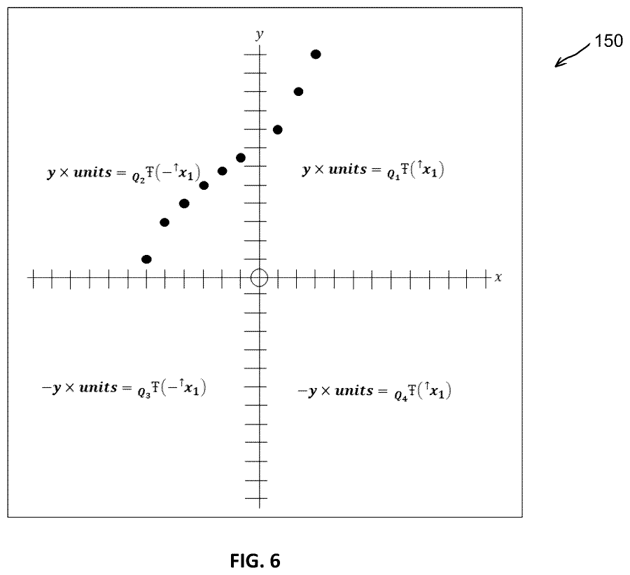

Graph 150 of FIG. 6 shows that if a monotonic curve crosses a quadrant boundary, it decomposes into curve segments whose un-scaled data points are used to generate two linked prediction polynomials in different quadrants. An ascending curve that starts in the second quadrant and ends in the first quadrant is depicted as two linked prediction polynomials that share an end point at the y-crossing. These equations represent the quadrant-crossing curve as two linked prediction polynomials.

f(^{⬆}x₁)=_{Q}_{₂} [symbol] (−^{⬆}x₁)⇔x₁≤−6 & x₁<0 and

f(^{⬆}x₁)=_{Q}_{₁} [symbol] (^{⬆}x₁)⇔x₁>0 & x₁≤3

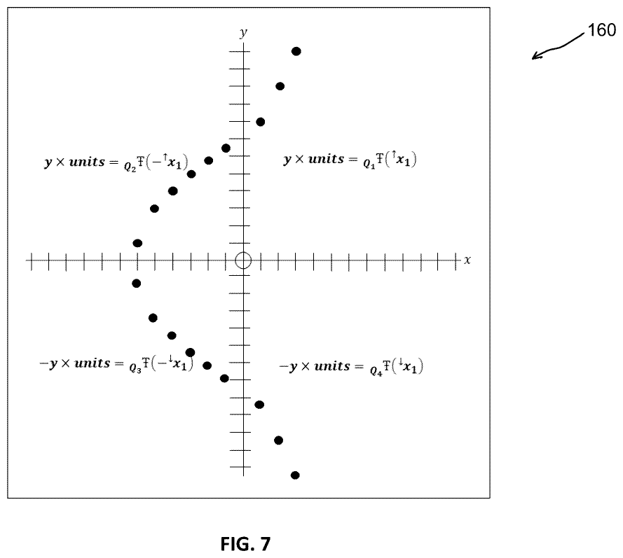

Graph 160 of FIG. 7 shows that it is also possible to depict curves that combine quadrant crossing with rising and falling. These equations represent the prediction polynomials generated from the curve segments decomposed from the curve that crosses quadrants and combines monotonic ascending and descending.

f(^{⬆}x₁)=_{Q}_{₂} [symbol] (−^{⬆}x₁)⇔x₁≥−6 & x₁<0 and

−f(^{⬆}x₁)=_{Q}_{₃} [symbol] (−^{⬇}x₁)⇔x₁≥−6 & x₁<0 and

f(^{⬆}x₁)=_{Q}_{₁} [symbol] (^{⬆}x₁)⇔x₁>0 & x₁≤3 and

−f(^{⬆}x₁)=_{Q}_{₄} [symbol] (⁵⁵⁷ x₁)⇔x₁>0 & x₁≤3

### Ascending and Descending Prediction Polynomial Interactions

A base T-polynomial herein is a T-polynomial with any constant that represents size and any left/right or up/down shifting removed, meaning only the shape of the curve is described.

$$Base T - Polynomial$$

$$d \times T ( c \times ( \frac{x}{{x}_{min}} = h ) \pm a ) \pm b = d \times T ( c \times h \pm a ) \pm b \to {}_{base} T ( h ) \qquad Equation 17$$

$$Where T ( \frac{x}{{x}_{min}} ) = T - polynomial$$

$$a = a constant used to shift T ( \frac{x}{{x}_{min}} ) left or right$$

$$b = a constant used to shift T ( \frac{x}{{x}_{min}} ) up or down$$

$$c = a constant used to change the size of a \\ T - polynomial along the x - axis$$

$$d = a constant used to change the size of a \\ T - polynomial along the y - axis$$

$${}_{base} T ( h ) = base T - polynomial$$

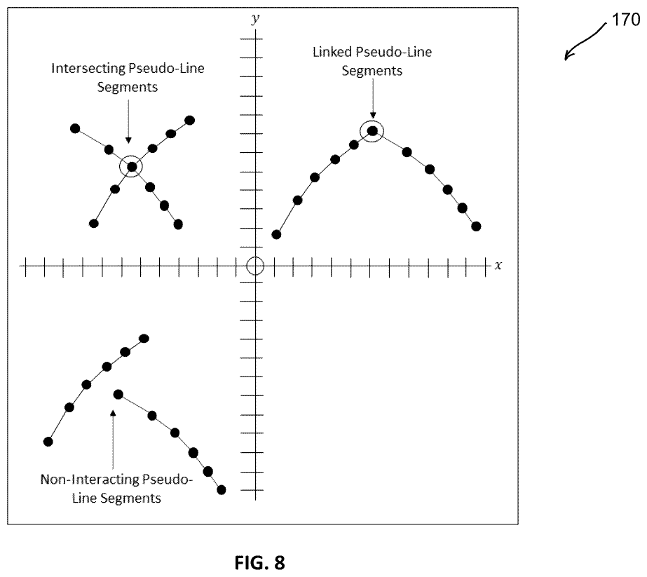

Referring to graph 170 of FIG. 8, if there are two equal base T-polynomials in the same quadrant then the following interactions can take place. Given equal ascending and descending base T-polynomials, their associated prediction polynomials, [symbol] ( ), behave toward each other as if they represented line segments, called herein TALP line segments, regardless of the shape of the curve described by _{base}T( ). That is, two or more prediction polynomials that represent two monotonic curves of the same shape in the same quadrant (same base T-polynomial) can be treated as if they were linear, regardless of their actual shape. This gives the following interactions.
1) Non-interaction—The TALP line segments do not intersect.
2) Intersection interaction—There is a shared y value:
   a. The shared y value is an endpoint for both TALP line segments, indicating a continuous curve consisting of two monotonic segments.
   b. The shared y value is not an endpoint, indicating an intersection.

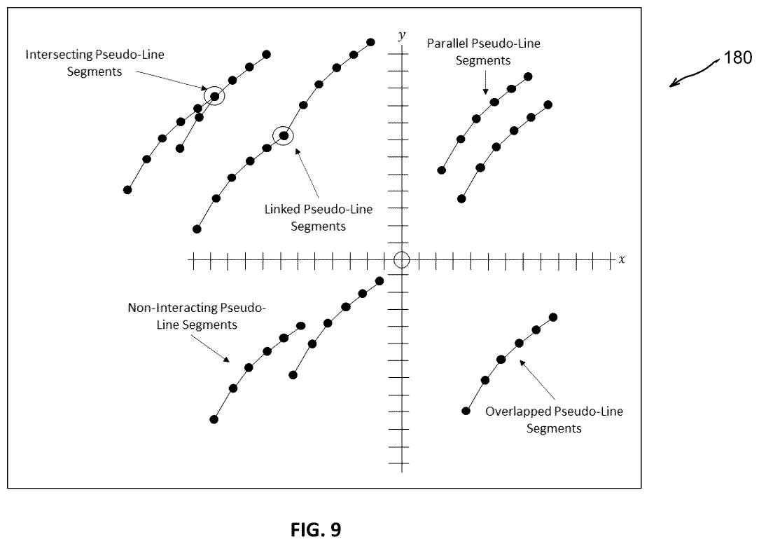

Referring to graph 180 of FIG. 9, if _{base}T₁(h₁)≡_{base}T₂(h₂) are in the same quadrant and are either ascending-ascending or descending-descending, then the two associated prediction polynomials, [symbol] ( ), behave toward each other as TALP line segments, regardless of the actual shape of the curves. This allows for four types of interactions between their associated prediction polynomials.
1) Non-interaction—There are no shared y values and the y values vary in distance from one another.
2) Parallel interaction—There are no shared y values and they values are a constant distance from one another, [symbol] ₁(x₁)∥ [symbol] ₂ (x₂).
3) Intersection interaction—There is a shared y value:
   a. The shared y value is an endpoint for both [symbol] ₁ (x₁) and [symbol] ₂ (x₂) indicating a continuous curve.
   b. The shared y value is not an endpoint for at least one indicating an intersection.
4) Overlapped interaction—All points are the same, [symbol] ₁ (x₁)≡ [symbol] ₂ (x₂).

Since the base T-polynomial represents the core shape of the prediction polynomial curve and, through various shifting and scaling factors, can represent any number of prediction polynomial curves, it is effective across multiple domains and ranges. Instead of requiring difficult-to-process non-linear mathematical techniques to solve algorithmic problems, this model decreases processing time by automatically determining when linear mathematical techniques can be used on non-linear functions. TALP Surface and TALP Volume Definition

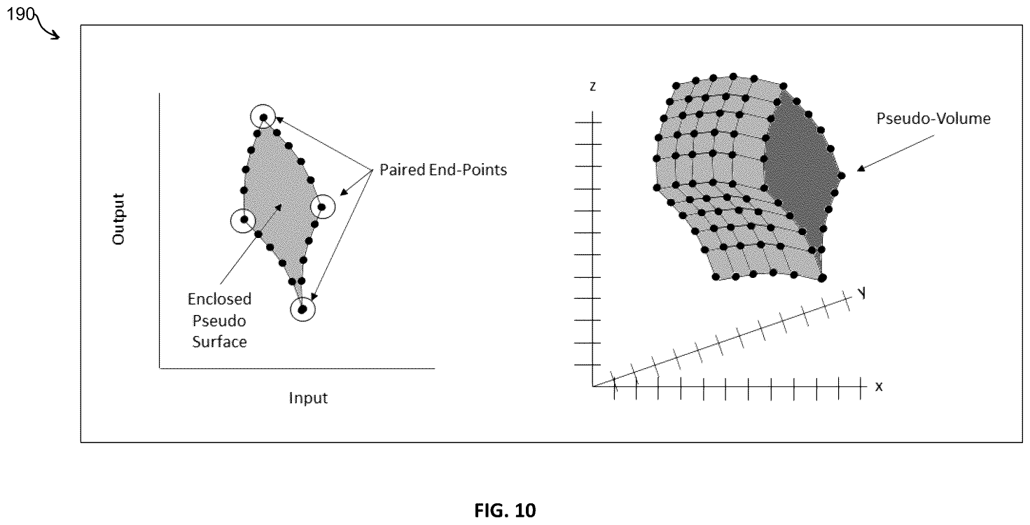

FIG. 10 shows, in graph 190, four curves that have base T-polynomials such that _{base}T₁(h₁)≡_{base}T₂(h₂)≡_{base}T₃(h₃)≡_{base}T₄(h₄) with four end points (starting or ending) that are the same in a pair-wise fashion or associated groups of such curves with the same base T-polynomial. The two-dimensional area enclosed by TALP line segments is called a TALP surface, which here is a TALP square. Similarly, a volume enclosed by curves of the same base T-polynomial are called TALP volumes, which here is a TALP rectangular cuboid.

TALP surfaces and TALP volumes are considered data objects. If the data object is performing a data transformation of any type, including moving or rotating within an array, it is considered an algorithm and decomposable into TALPs. It is possible to compare two or more data objects by comparing their associated base T-polynomials. When the underlying base T-polynomials of data objects are equal, then the data objects represent the same class (type or category of data objects) of data object. If their associated prediction polynomials are equal, then they may represent the same data object. If they do represent the same data object and the orientation of that object within an array changes over time, then that data object is considered to be in rotation. If the array position of that data object changes over time, that data object is considered to be in motion. This means that complex data objects and their behaviors can be represented as prediction polynomials, and their classes can be represented as base T-polynomials.

If the prediction polynomials do not represent the same data object but do represent the same class of data object, then analogous prediction polynomials can be compared. If all T-polynomials of a data object give the same values, then that data object is considered perfect. A perfect data object has considerable advantage over imperfect ones because only a single prediction polynomial needs to be calculated for the data object, rather than one for each prediction polynomial of the data object. If all base T-polynomials of a data object give the same value, then that class of data object is considered perfect. Similarly, if all T-polynomials of a TALP or OALP give the same value then that TALP or OALP is considered to be perfect. If all base T-polynomials of a TALP or OALP give the same value then the class of that TALP or OALP is considered perfect.

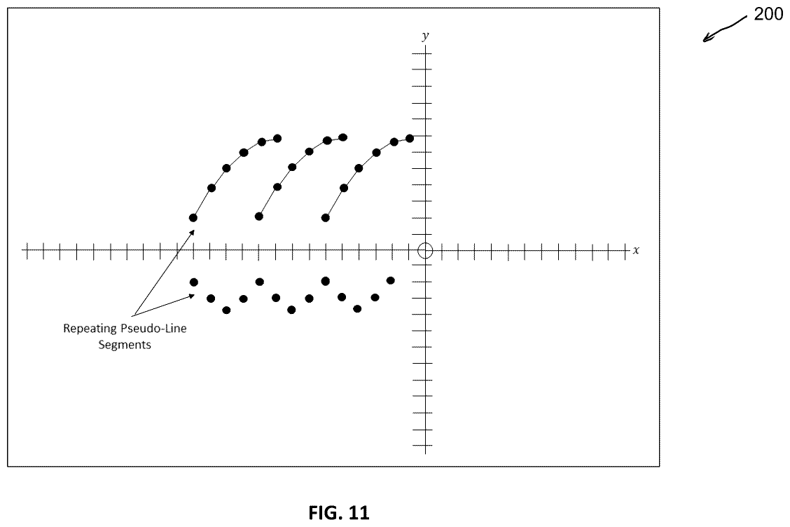

Referring to graph 200 of FIG. 11, if there are one or more prediction polynomials that repeat, then they can be grouped, regardless of the quadrant or the ascending or descending characteristic as long as the repetition is in the same quadrant. These repeating prediction polynomials are considered TALP line segments.

[symbol]

ᵢ₌ₛₜₐᵣₜ^{end}(_{Q}_{₂} [symbol] (−^{⬆}x₁)⇔(x₁≥((−6×i))&(x₁×i)<0)) Equation 18 Example of Repeating Prediction Polynomial Notation

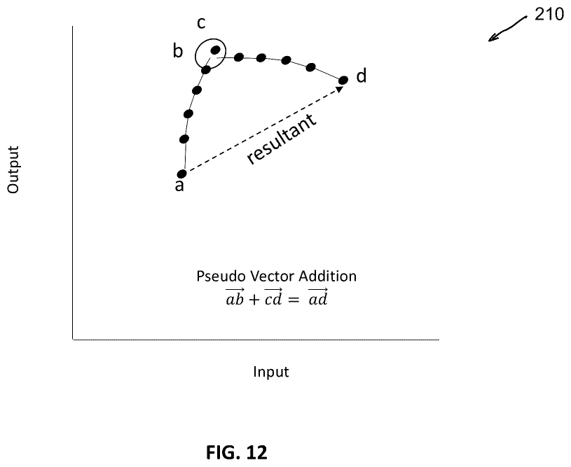

Referring to graph 210 of FIG. 12, if there are two prediction polynomials with equal associated base T-polynomials, meaning that the two prediction polynomials can interact as if they were line segments, that is, TALP line segments, then each TALP line segment that has a starting and an ending point is considered a directed TALP line segment, which acts as a TALP vector. If the end point of one TALP vector is the starting point of another TALP vector, then the standard method of vector addition and subtraction can be performed using those TALP vectors.

The use of TALP vectors can greatly decrease the number of calculations required to solve equations with greater than linear powers. It should be noted that the resultant from adding or subtracting two TALP vectors is a standard vector. Multiple TALP vectors each with the same base T-polynomial and orientation can form a TALP vector field that is analogous to vector fields in physics, but able to describe more complex interactions.

### Inverse Prediction Polynomials

The inverse ascending prediction polynomial equation in standard form generates x, given y. The inverse values in each quadrant can be calculated analogously to per-quadrant ascending prediction polynomial equations, which generate y, given x. Following each inverse ascending prediction polynomial equation below is the same equation in vector form.

$$Quadrant 1 , Ascending Inverse Prediction Polynomial , Standard Form$$

$$x \times units {=}_{{Q}_{1}} {- 1}^{} ( {}^{↑} {y}_{1} ) = ( T ( \frac{{y}_{1}}{{y}_{min}} ) \times {x}_{min} ) \times units ⇔ ( {y}_{min} \neq 0 , {y}_{1} \geq {y}_{min} \& {y}_{1} \leq {y}_{max} ) \qquad Equation 19$$

$$Quadrant 1 , Ascending Inverse Vector Prediction Polynomial , \\ Standard Form$$

$$x \times units \times Q {1}_{ascending} {=}_{{Q}_{1}} {- 1}^{} ( {}^{↑} {y}_{1} ) = ( T ( \frac{{y}_{1}}{{y}_{min}} ) \times {x}_{min} ) \times units \times Q {1}_{ascending} \qquad Equation 20$$

$$Quadrant 2 , Ascending Inverse Vector Prediction Polynomial , \\ Standard Form$$

$$- x \times units = {}_{{Q}_{2}}^{} {}_{- 1}^{} ( {}_{}^{↑} {y}_{1}^{} ) = - T ( \frac{{y}_{1}}{{y}_{min}} ) \times {x}_{min} \times units \qquad Equation 21$$

$$Quadrant 2 , Ascending Inverse Vector Prediction Polynomial , \\ Standard Form$$

$$- x \times units \times Q {2}_{ascending} = {}_{{Q}_{2}}^{} {}_{- 1}^{} ( {}^{↑} {y}_{1} ) = - T ( \frac{{y}_{1}}{{y}_{min}} ) \times {x}_{min} \times units \times Q {2}_{ascending} \qquad Equation 22$$

$$Quadrant 3 , Ascending Inverse Prediction Polynomial , Standard Form$$

$$- x \times units = {}_{{Q}_{3}}^{} {}_{- 1}^{} ( - {}_{}^{↑} {y}_{1}^{} ) = - T ( \frac{\vert - {y}_{1} \vert}{{y}_{min}} ) \times {x}_{min} \times units \qquad Equation 23$$

$$Quadrant 3 , Ascending Inverse Vector Prediction Polynomial , \\ Standard Form$$

$$- x \times units \times Q {3}_{ascending} = {}_{{Q}_{3}} {1}^{} ( - {}_{}^{↑} {y}_{1}^{} ) = - T ( \frac{\vert - {y}_{1} \vert}{{y}_{min}} ) \times {x}_{min} \times units \times Q {3}_{ascending} \qquad Equation 24$$

$$Quadrant 4 , Ascending Inverse Prediction Polynomial , Standard Form$$

$$x \times units = {}_{{Q}_{4}} {- 1}^{} ( - {}_{}^{↑} {y}_{1}^{} ) = T ( \frac{\vert - {y}_{1} \vert}{{y}_{min}} ) \times {x}_{min} \times units \qquad Equation 25$$

$$Quadrant 4 , Ascending Inverse Vector Prediction Polynomial , \\ Standard Form$$

$$x \times units \times Q {4}_{ascending} = {}_{{Q}_{4}} {- 1}^{} ( - {}_{}^{↑} {y}_{1}^{} ) = T ( \frac{\vert - {y}_{1} \vert}{{y}_{min}} ) \times {x}_{min} \times units \times Q {4}_{ascending} \qquad Equation 26$$

As with the ascending prediction polynomial equations, the descending prediction polynomial equations have inverses. Following each inverse descending prediction polynomial equation below is the same equation in vector form.

$$Quadrant 1 , Inverse Descending Prediction Polynomial , Standard Form$$

$$x \times units = {}_{{Q}_{1}} {- 1}^{} ( {}_{}^{↓} {y}_{1}^{} ) = \frac{T ( {y}_{max} )}{T ( \frac{{y}_{1}}{{y}_{min}} )} \times {x}_{min} \times units \qquad Equation 27$$

$$Quadrant 1 , Inverse Descending Vector Prediction Polynomial , \\ Standard Form$$

$$x \times units \times Q {1}_{descending} = {}_{{Q}_{1}} {- 1}^{} ( {}_{}^{↓} {y}_{1}^{} ) = \frac{T ( {y}_{max} )}{T ( \frac{{y}_{1}}{{y}_{min}} )} \times {x}_{min} \times units \times Q {1}_{descending} \qquad Equation 28$$

$$Quadrant 2 , Inverse Descending Prediction Polynomial , Standard Form$$

$$- x \times units = {}_{{Q}_{2}} {- 1}^{} ( {}_{}^{↓} {y}_{1}^{} ) = - \frac{T ( {y}_{max} )}{T ( \frac{{y}_{1}}{{y}_{min}} )} \times {x}_{min} \times units \qquad Equation 29$$

$$Quadrant 2 , Inverse Descending Vector Prediction Polynomial , \\ Standard Form$$

$$- x \times units \times Q {2}_{descending} = {}_{{Q}_{2}} {- 1}^{} ( {}_{}^{↑} {y}_{1}^{} ) = - \frac{T ( {y}_{max} )}{T ( \frac{{y}_{1}}{{y}_{min}} )} \times {x}_{min} \times units \times Q {2}_{descending} \qquad Equation 30$$

$$Quadrant 3 , Inverse Descending Prediction Polynomial , Standard Form$$

$$- x \times units = {}_{{Q}_{3}} {- 1}^{} ( - {}_{}^{↓} {y}_{1}^{} ) = - \frac{T ( {y}_{max} )}{T ( \frac{\vert - {y}_{1} \vert}{{y}_{min}} )} \times {x}_{min} \times units \qquad Equation 31$$

$$Quadrant 3 , Inverse Descending Vector Prediction Polynomial , \\ Standard Form$$

$$- x \times units \times Q {3}_{descending} = {}_{{Q}_{3}}^{} {}_{- 1}^{} ( - {}_{}^{↓} {y}_{1}^{} ) = - \frac{T ( {y}_{max} )}{T ( \frac{\vert - {y}_{1} \vert}{{y}_{min}} )} \times {x}_{min} \times units \times Q {3}_{descending} \qquad Equation 32$$

$$Quadrant 4 , Inverse Descending Prediction Polynomial , Standard Form$$

$$- x \times units = {}_{{Q}_{4}}^{} {}_{- 1}^{} ( {}_{}^{↓} {y}_{1}^{} ) = - \frac{T ( {y}_{max} )}{T ( \frac{{y}_{1}}{{y}_{min}} )} \times {x}_{min} \times units \qquad Equation 33$$

$$Quadrant 4 , Inverse Descending Vector Prediction Polynomial , \\ Standard Form$$

$$- x \times units \times Q {4}_{descending} = {}_{{Q}_{4}}^{} {- 1}^{} ( {}_{}^{↓} {y}_{1}^{} ) = - \frac{T ( {y}_{max} )}{T ( \frac{{y}_{1}}{{y}_{min}} )} \times {x}_{min} \times units \times Q {4}_{descending} \qquad Equation 34$$

An ascending prediction polynomial symbol, [symbol] (^{⬆}x₁), means that entering x min into an ascending prediction polynomial generates yₘᵢₙ while enter xₘᵢₙ into a descending T-polynomial, [symbol] (^{⬇}x₁), generates yₘₐₓ. It should be noted that if neither the ascending nor the descending symbols are associated with a prediction polynomial then either ascending or descending prediction polynomials can be used, depending on the monotonicity of the curve, [symbol] (x₁).

### Prediction Polynomial Equation General (Parallel) Form

Evenly spreading the input attribute value x₁ over n processing elements gives the effect of

$$\frac{{x}_{1}}{n} = {x}_{n}$$

as the input value per processing element. The first equation below shows the effect of the input variable attribute values on a single processing element for the execution of a TALP or OALP. The second equation below shows the effect of the input variable attribute values spread evenly across n processing elements for the execution of a TALP or OALP.

$$Set of Input Variable Attribute Values$$

$$x = \{ \begin{matrix}{P}_{1 , 1} , {P}_{1 , 2} , … , {P}_{1 , a} , \\ {P}_{2 , 1} , {P}_{2 , 2} , … , {P}_{2 , a} , \\ … , \\ {P}_{v , 1} , {P}_{v , 2} , … , {P}_{v , a}\end{matrix} \} \qquad Equation 35$$

Where: P=Input variable attribute values of a TALP
   v=Input variable indicator
   a=Input variable attribute indicator

$$Input Variable Attribute Values for n Processing Elements$$

$${x}_{n} = \frac{{x}_{1}}{n} = \{ \begin{matrix}\frac{{P}_{1 , 1}}{n} , \frac{{P}_{1 , 2}}{n} , … , \frac{{P}_{1 , a}}{n} , \\ \frac{{P}_{2 , 1}}{n} , \frac{{P}_{2 , 2}}{n} , … , \frac{{P}_{2 , a}}{n} , \\ … , \\ \frac{{P}_{v , 1}}{n} , \frac{{P}_{v , 2}}{n} , … , \frac{{P}_{v , a}}{n}\end{matrix} \} \qquad Equation 36$$

Within an ascending prediction polynomial,

$$\frac{{x}_{1}}{n} = {x}_{n} .$$

When n=1, we get y×units×

$${Q}_{ascending} = ( T ( \frac{{x}_{1}}{{x}_{min}} ) \times {y}_{min} ) \times units \times {Q}_{ascending} ,$$

the prediction polynomial equation in standard form. Since n can either equal the number of processing elements or the effect of the number of processing elements on input variable attributes, the general form extends the ability of the prediction polynomial to the parallel execution of the TALP or OALP on multiple processing elements.

Since the evenly spread input attribute values give the same effect on each processing element, the general form of the prediction polynomial standard equation is the per processing element effect. The general forms of per-quadrant ascending prediction polynomials are shown below. Following each is the same equation in vector form.

$$Quadrant 1 , Ascending Scalar Prediction Polynomial , General Form$$

$$y \times units = {}_{{Q}_{1}} ( {}^{↑} {x}_{1} , n ) = T ( \frac{{x}_{n}}{{x}_{min}} ) \times {y}_{min} \times units ⇔ ( {x}_{min} \neq 0 , {x}_{n} \geq {x}_{min} \& {x}_{n} \leq {x}_{max} ) \qquad Equation 37$$

$$Where {}_{{Q}_{1}} ( {}^{↑} {x}_{1} , n ) = quadrant 1 ascending prediction polynomial$$

$$T ( \frac{{x}_{n}}{{x}_{min}} ) = parallel effect T - polynomial$$

$$n = number of processing elements$$

$$Quadrant 1 , Ascending Vector Prediction Polynomial , General Form$$

$$y \times units \times Q {1}_{ascending} = {}_{{Q}_{1}} ( {}^{↑} {x}_{1} , n ) = T ( \frac{{x}_{n}}{{x}_{min}} ) \times {y}_{min} \times units \times Q {1}_{ascending} \qquad Equation 38$$

$$Quadrant 2 , Ascending Scalar Prediction Polynomial , General Form$$

$$y \times units = {}_{{Q}_{2}} ( - {}^{↑} {x}_{1} , n ) = T ( \frac{\vert - {x}_{n} \vert}{{x}_{min}} ) \times {y}_{min} \times units \qquad Equation 39$$

$$Quadrant 2 , Ascending Vector Prediction Polynomial , General Form$$

$$y \times units \times Q {2}_{ascending} = {}_{{Q}_{2}} ( - {}^{↑} {x}_{1} , n ) = T ( \frac{\vert - {x}_{n} \vert}{{x}_{min}} ) \times {y}_{min} \times units \times Q {2}_{ascending} \qquad Equation 40$$

$$Quadrant 3 , Ascending Scalar Prediction Polynomial , General Form$$

$$- y \times units = {}_{{Q}_{3}} ( - {}^{↑} {x}_{1} , n ) = - T ( \frac{\vert - {x}_{n} \vert}{{x}_{min}} ) \times {y}_{min} \times units \qquad Equation 41$$

$$Quadrant 3 , Ascending Vector Prediction Polynomial , General Form$$

$$- y \times units \times Q {3}_{ascending} = {}_{{Q}_{3}} ( - {}^{↑} {x}_{1} , n ) = - T ( \frac{\vert - {x}_{n} \vert}{{x}_{min}} ) \times {y}_{min} \times units \times Q {3}_{ascending} \qquad Equation 42$$

$$Quadrant 4 , Ascending Scalar Prediction Polynomial , General Form$$

$$- y \times units = {}_{{Q}_{4}} {(}^{↑} {x}_{1} , n ) = - T ( \frac{{x}_{n}}{{x}_{min}} ) \times {y}_{min} \times units \qquad Equation 43$$

$$Quadrant 4 , Ascending Vector Prediction Polynomial , General Form$$

$$- y \times units \times Q {4}_{ascending} = {}_{{Q}_{4}} ( {}^{↑} {x}_{1} , n ) = - T ( \frac{{x}_{n}}{{x}_{min}} ) \times {y}_{min} \times units \times Q {4}_{ascending} \qquad Equation 44$$

Analogously, we can define the per-quadrant descending prediction polynomial equation general forms below, followed by their vector forms.

$$Quadrant 1 , Descending Scalar Prediction Polynomial , General Form$$

$$y \times units = {Q}_{1} ( {}^{↓} {x}_{1} , n ) = \frac{T ( {x}_{max} )}{T ( \frac{{x}_{n}}{{x}_{min}} )} \times {y}_{min} \times units ⇔ ( T ( \frac{{x}_{n}}{{x}_{min}} ) \neq 0 , T ( \frac{{x}_{n}}{{x}_{min}} ) \leq T ( {x}_{max} ) ) \qquad Equation 45$$

$$Quadrant 1 , Descending Vector Prediction Polynomial , General Form$$

$$y \times units \times Q {1}_{descending} = {Q}_{1} ( {}^{↓} {x}_{1} , n ) = \frac{T ( {x}_{max} )}{T ( \frac{{x}_{n}}{{x}_{min}} )} \times {y}_{min} \times units \times Q {1}_{descending} \qquad Equation 46$$

$$Quadrant 2 , Descending Scalar Prediction Polynomial , General Form$$

$$y \times units = {Q}_{2} ( - {}^{↓} {x}_{1} , n ) = \frac{T ( {x}_{max} )}{T ( \frac{\vert - {x}_{n} \vert}{{x}_{min}} )} \times {y}_{min} \times units \qquad Equation 47$$

$$Quadrant 2 , Descending Vector Prediction Polynomial , General Form$$

$$y \times units \times Q {2}_{descending} = {Q}_{2} ( - {}^{↓} {x}_{1} , n ) = \frac{T ( {x}_{max} )}{T ( \frac{\vert - {x}_{n} \vert}{{x}_{min}} )} \times {y}_{min} \times units \times Q {2}_{descending} \qquad Equation 48$$

$$Quadrant 3 , Descending Scalar Prediction Polynomial , General Form$$

$$- y \times units = {Q}_{3} ( - {}^{↓} {x}_{1} , n ) = - \frac{T ( {x}_{max} )}{T ( \frac{\vert - {x}_{n} \vert}{{x}_{min}} )} \times {y}_{min} \times units \qquad Equation 49$$

$$Quadrant 3 Descending Vector Prediction Polynomial , General Form$$

$$- y \times units \times Q {3}_{descending} = {Q}_{3} ( - {}^{↓} {x}_{1} , n ) = - \frac{T ( {x}_{max} )}{T ( \frac{\vert - {x}_{n} \vert}{{x}_{min}} )} \times {y}_{min} \times units \times Q {3}_{descending} \qquad Equation 50$$

$$Quadrant 4 , Descending Scalar Prediction Polynomial , General Form$$

$$y \times units \times = {Q}_{4} ( {}^{↓} {x}_{1} , n ) = - \frac{T ( {x}_{max} )}{T ( \frac{{x}_{n}}{{x}_{min}} )} \times {y}_{min} \times units \qquad Equation 51$$

$$Quadrant 4 Descending Vector Prediction Polynomial , General Form$$

$$- y \times units \times Q {4}_{descending} = {Q}_{4} ( {}^{↓} {x}_{1} , n ) = - \frac{T ( {x}_{max} )}{T ( \frac{{x}_{n}}{{x}_{min}} )} \times {y}_{min} \times units \times Q {4}_{descending} \qquad Equation 52$$

As with the standard form, the general equation forms can have inverses.

$$Quadrant 1 , Inverse Ascending Scalar Prediction Polynomial , General Form$$

$$x \times units = {Q}_{1} {- 1}^{} ( {}^{↑} {y}_{1} , n ) = T ( \frac{{y}_{n}}{{y}_{min}} ) \times {x}_{min} \times units ⇔ ( {y}_{min} \neq 0 , {y}_{n} \geq {y}_{min} \& {y}_{n} \leq {y}_{max} ) \qquad Equation 53$$

$$Quadrant 1 , Inverse Ascending Vector Prediction Polynomial , General Form$$

$$x \times units \times Q {1}_{ascending} = {Q}_{1} {- 1}^{} ( {}^{↑} {y}_{1} , n ) = T ( \frac{{y}_{n}}{{y}_{min}} ) \times {x}_{min} \times units \times Q {1}_{ascending} \qquad Equation 54$$

$$Quadrant 2 , Inverse Ascending Scalar Prediction Polynomial , General Form$$

$$- x \times units = {Q}_{2} {- 1}^{} ( {}^{↑} {y}_{1} , n ) = - T ( \frac{{y}_{n}}{{y}_{min}} ) \times {x}_{min} \times units \qquad Equation 55$$

$$Quadrant 2 , Inverse Ascending Vector Prediction Polynomial , General Form$$

$$- x \times units \times Q {2}_{ascending} = {Q}_{2} {- 1}^{} ( {}^{↑} {y}_{1} , n ) = - T ( \frac{{y}_{n}}{{y}_{min}} ) \times {x}_{min} \times units \times Q {2}_{ascending} \qquad Equation 56$$

$$Quadrant 3 , Inverse Ascending Scalar Prediction Polynomial , General Form$$

$$- x \times units = {Q}_{3} {- 1}^{} ( - {}^{↑} {y}_{1} , n ) = - T ( \frac{\vert - {y}_{n} \vert}{{y}_{min}} ) \times {x}_{min} \times units \qquad Equation 57$$

$$Quadrant 3 , Inverse Ascending Vector Prediction Polynomial , General Form$$

$$- x \times units \times Q {3}_{ascending} = {Q}_{3} {- 1}^{} ( - {}^{↑} {y}_{1} , n ) = - T ( \frac{\vert - {y}_{n} \vert}{{y}_{min}} ) \times {x}_{min} \times units \times Q {3}_{ascending} \qquad Equation 58$$

$$Quadrant 4 , Inverse Ascending Scalar Prediction Polynomial , General Form$$

$$x \times units = {Q}_{4} {- 1}^{} ( - {}^{↑} {y}_{1} , n ) = T ( \frac{\vert - {y}_{n} \vert}{{y}_{min}} ) \times {x}_{min} \times units \qquad Equation 59$$

$$Quadrant 4 , Inverse Ascending Vector Prediction Polynomial , General Form$$

$$x \times units \times Q {4}_{ascending} = {Q}_{4} {- 1}^{} ( - {}^{↑} {y}_{1} , n ) = T ( \frac{\vert - {y}_{n} \vert}{{y}_{min}} ) \times {x}_{min} \times units \times Q {4}_{ascending} \qquad Equation 60$$

The inverse descending prediction polynomial equation in general form predicts x given y as input is evenly spread over n processing elements.

$$Quadrant 1 Inverse Descending Scalar Prediction Polynomial , General Form$$

$$x \times units = {Q}_{1} {- 1}^{} ( {}^{↓} {y}_{1} , n ) = \frac{T ( {y}_{max} )}{T ( \frac{{y}_{n}}{{y}_{min}} )} \times {x}_{min} \times units \qquad Equation 61$$

$$Quadrant 1 Inverse Descending Vector Prediction Polynomial , General Form$$

$$x \times units \times Q {1}_{descending} = {Q}_{1} {- 1}^{} ( {}^{↓} {y}_{1} , n ) = \frac{T ( {y}_{max} )}{T ( \frac{{y}_{n}}{{y}_{min}} )} \times {x}_{min} \times units \times Q {1}_{descending} \qquad Equation 62$$

$$Quadrant 2 Inverse Descending Scalar Prediction Polynomial , General Form$$

$$- x \times units = {Q}_{2} {- 1}^{} ( {}^{↓} {y}_{1} , n ) = - \frac{T ( {y}_{max} )}{T ( \frac{{y}_{n}}{{y}_{min}} )} \times {x}_{min} \times units \qquad Equation 63$$

$$Quadrant 2 Inverse Descending Vector Prediction Polynomial , General Form$$

$$- x \times units \times Q {2}_{descending} = {Q}_{2} {- 1}^{} ( {}^{↓} {y}_{1} , n ) = - \frac{T ( {y}_{max} )}{T ( \frac{{y}_{n}}{{y}_{min}} )} \times {x}_{min} \times units \times Q {2}_{descending} \qquad Equation 64$$

$$Quadrant 3 Inverse Descending Scalar Prediction Polynomial , General Form$$

$$- x \times units = {Q}_{3} {- 1}^{} ( - {}^{↓} {y}_{1} , n ) = - \frac{T ( {y}_{max} )}{T ( \frac{\vert - {y}_{n} \vert}{{y}_{min}} )} \times {x}_{min} \times units \qquad Equation 65$$

$$Quadrant 3 Inverse Descending Vector Prediction Polynomial , General Form$$

$$- x \times units \times Q {3}_{descending} = {Q}_{3} {- 1}^{} ( - {}^{↓} {y}_{1} , n ) = - \frac{T ( {y}_{max} )}{T ( \frac{\vert - {y}_{n} \vert}{{y}_{min}} )} \times {x}_{min} \times units \times Q {3}_{descending} \qquad Equation 66$$

$$Quadrant 4 Inverse Descending Scalar Prediction Polynomial , General Form$$

$$x \times units = {Q}_{4} {- 1}^{} ( - {}^{↓} {y}_{1} , n ) = \frac{T ( {y}_{max} )}{T ( \frac{\vert - {y}_{n} \vert}{{y}_{min}} )} \times {x}_{min} \times units \qquad Equation 67$$

$$Quadrant 4 Inverse Descending Vector Prediction Polynomial , General Form$$

$$x \times units \times Q {4}_{descending} = {Q}_{4} {- 1}^{} ( - {}^{↓} {y}_{1} , n ) = \frac{T ( {y}_{max} )}{T ( \frac{\vert - {y}_{n} \vert}{{y}_{min}} )} \times {x}_{min} \times units \times Q {4}_{descending} \qquad Equation 68$$

### TALP and OALP T-Polynomial Generation

The primary tools used to generate a T-polynomial are the source values tables and the extend target values table by adding first and second derivative terms.

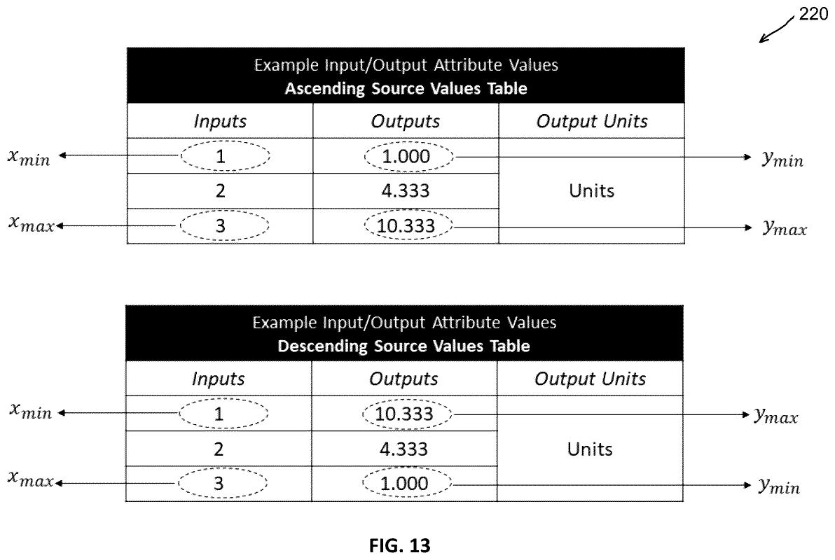

FIG. 13 shows an example 220 of two source values tables showing the scaled values used to find the ascending T-polynomial and the same scaled input values used to find as its descending counterpart.

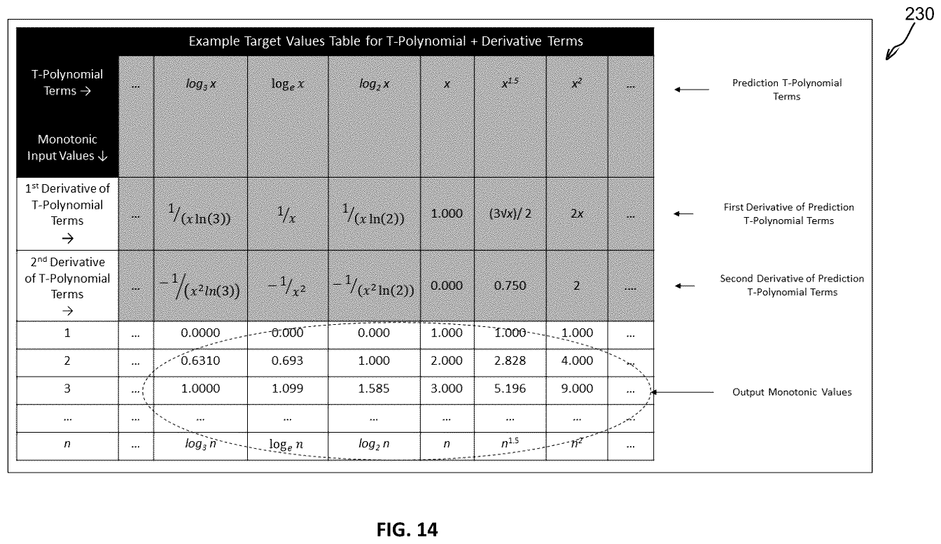

FIG. 14 shows an example 230 of an extended target values table where the primary tools for analyzing either a TALP or an OALP are the T-polynomials:

$$T ( \frac{{x}_{n}}{{x}_{min}} )$$

for ascending or

$$\frac{T ( {x}_{max} )}{T ( \frac{{x}_{n}}{{x}_{min}} )}$$

for descending sets of monotonic values.

Unlike known methods and techniques, the target values table, which only includes a header of monotonic polynomial terms, the present invention's extended target values table includes three headers of monotonic polynomial and monotonic non-polynomial terms: T-polynomial prediction terms, first derivative of the T-polynomial prediction terms, and second derivative of the T-polynomial prediction terms. It should be noted that the extended target values table headers are not limited to first and second derivatives but can have any number of derivative levels.

Each T-polynomial term header is the algebraic depiction of the term used to generate a particular column in the extended target values table. The first derivative of each T-polynomial term header includes an algebraic depiction of the first derivative of the T-polynomial term of the current column. The second derivative of the T-polynomial term header includes an algebraic depiction of the second derivative of the T-polynomial term of the current column.

These header terms are followed by the bulk of the extended target values table, called output monotonic values. The first column of the output monotonic values lists the input values given to the T-polynomial term of a selected column. That is, it associates some set of input attribute values, x, starting with some smallest value and the various output values generated by the algebraic depictions of the T-polynomial terms of each column.

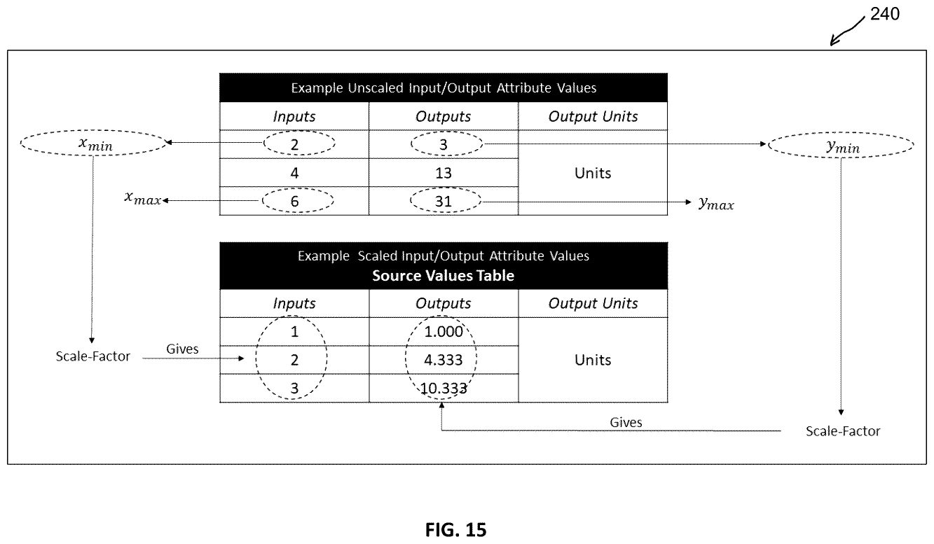

Referring to example 240 of FIG. 15, given a list of input variable attribute values of some unknown algorithm and its associated set of output values from that same algorithm, those two sets of values are saved together in a table. The values of both the inputs and outputs must be monotonic and are sorted from smallest to largest. The smallest values of each column are used as scale factors to scale the given input and output values. These scaled values are entered into a new table called the source values table. The scale factors (minimum values) of each column are retained.

The extended target values table and the source values table can now be used to generate a T-polynomial. By comparing the values of the source values table first column to first-column values of the extended target values table and the associated second-column values of the source values table to the particular non-first column values, a best fit of the source values table and the extended target values table can be determined. The best-fitting extended target values table column will have its T-polynomial term saved and the values of the associated extended target values table column subtracted from the source values table values.

The resulting new source values table is then used again to find a new, best-fitting extended target values table column, with the resulting T-polynomial term also saved. This activity is repeated until it is no longer possible to match the source values table values to any columns of the extended target values table. If the original set of source values table values was monotonically ascending, then the saved T-polynomial terms are summed together, giving the polynomial. It is possible to generate duplicate terms in this manner. Duplicate terms are added together. Once all duplicate terms are summed, giving their coefficients, they can be linked together, added to the smallest value for ascending monotonic values or subtracted from the largest values for descending monotonic values.

The following steps are used to generate a T-polynomial:
1. A paired set of input variable attribute values x and associated output attribute values y are received.
2. The input variable attribute values x and associated output attribute values y are scaled by their respective smallest received values, xₘᵢₙ and yₘᵢₙ, and saved in a source values table. In the example, xₘᵢₙ=2 and yₘᵢₙ=3. Scaling gives the source values table column.
3. The scaled associated values y of the source values table are compared to those found in a previously created extended target values table.
4. The T-polynomial terms of the column header of the extended target values table are in ascending order. Any zero value in the extended target values table is ignored; however, not comparing a row does not eliminate the corresponding extended target values table column term from consideration for inclusion in the final T-polynomial. When comparing the source values table values to corresponding extended target values table values, all source values table values in a column must be one of the following:
   a. Greater than or equal to all associated extended target values table values in a column,
   b. Less than or equal to all associated extended target values table values in a column, or
   c. All source values table values are the same value, that is, a constant.

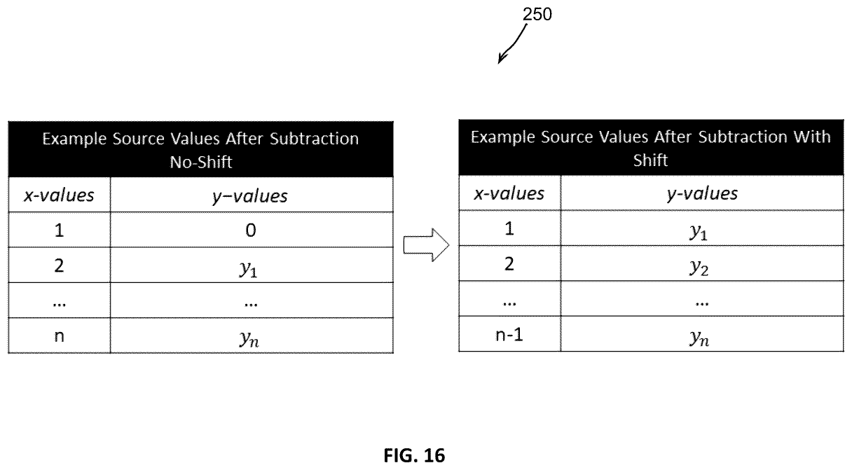

The T-polynomial term of any extended target values table column whose rows do not meet condition a or condition b above is eliminated from consideration for inclusion in the final T-polynomial, and a comparison is made using a different extended target column. If condition c is met, the value is considered a constant and added to a saved term list, fₜₑᵣₘ(x). Because the derivative of a constant equals zero, no term is added to the saved first derivative term list, \dot{f}ₜₑᵣₘ(x) or the saved second derivative term list. Condition c means the T-polynomial is complete, and control is transferred to Step 8.
5. When source values table values are compared to the corresponding extended target values table values, the closest T-polynomial term that meets condition a or b is saved in fₜₑᵣₘ(x) list while the corresponding first derivative term is saved in \dot{f}ₜₑᵣₘ(x)and the corresponding second derivative term in \ddot{f} term (x), and the process continues with Step 6. If no tested columns meet condition a or b then an error condition exists, and the “error-stop processing” message is displayed and the process is halted. This comparison is a binary search process.
6. The selected extended target values table column's values are subtracted from the corresponding source values table values, and those new values are saved in a temporary source values table. If the temporary source values include any negative values, then the following found T-polynomial term may be a negative term, in which case two versions of the term (negative and positive) are saved with the one whose maximum error (as calculated in step 9) is the smallest becoming the selected version. The absolute values of the temporary source values table values are saved as the new source values table.
7. FIG. 16 shows a table example 250 where if there are any computed zero values in the new source values table, the values of the current column below the zero are shifted to the row above, replacing the zero value if monotonically increasing or shifted to the row below, replacing the zero value, if monotonically decreasing. Step 4 is then repeated using the new source values table.
8. When the increasing source values table is used then all saved terms in each list of the

$${f}_{term} ( \frac{{x}_{1}}{{x}_{min}} ) , {\dot{f}}_{term} ( \frac{{x}_{1}}{{x}_{min}} ) , and {\ddot{f}}_{term} ( \frac{{x}_{1}}{{x}_{min}} )$$

terms are summed separately, creating the ascending T-polynomial

$$T ( \frac{{x}_{1}}{{x}_{min}} ) ,$$

the first derivative T-polynomial

$$\dot{T} ( \frac{{x}_{1}}{{x}_{min}} ) ,$$

and the second derivative T-polynomial,

$$\ddot{T} ( \frac{{x}_{1}}{{x}_{min}} ) .$$

When a descending source values table is used, the descending T-polynomial is found. Un-scaling the T-polynomials requires each to be multiplied by the smallest original y value, called yₘᵢₙ, within the original source values table and the original unit of measurement, giving the prediction polynomial.

$$T - Polynomial from Ascending Source Values Table Values$$

$$y \times units \times ascending = ( {}^{↑} {x}_{1} ) = ( T ( \frac{{x}_{1}}{{x}_{min}} ) \times {y}_{min} ) \times units \times ascending = {\sum }_{i = 1}^{n} ( {f}_{{term}_{i}} ( {}^{↑} {x}_{1} ) ) \times {y}_{min} \times units \times ascending \qquad Equation 69$$

$$Prediction Polynomial from Descending Source Values Table Values$$

$$y \times units \times descending = ( {}^{↓} {x}_{1} ) = \frac{T ( {x}_{max} )}{T ( \frac{{x}_{1}}{{x}_{min}} )} \times {y}_{min} \times units \times descending = {\sum }_{i = 1}^{n} ( {f}_{{term}_{i}} ( {}^{↓} {x}_{1} ) ) \times {y}_{min} \times units \times descending \qquad Equation 70$$

9. To test the accuracy of the generated T-polynomial, it is executed using the same values used to create the original source values table. The input/output values from executing the T-polynomial are compared to the source values table stored input/output values, giving the maximum percentage difference as the maximum error, Errorₘₐₓ. The equations below show maximum error computations for ascending, inverse ascending, descending, and inverse descending T-polynomials.

$$Maximum T - Polynomial Error When Using the Extended Target Values Table$$

$${}^{↑} {Error}_{max} = max ( \{ \frac{\vert {y}_{1} - T ( \frac{{x}_{1}}{{x}_{min}} ) \vert}{{y}_{1}} \times 100 , \\ \frac{\vert {y}_{2} - T ( \frac{{x}_{2}}{{x}_{min}} ) \vert}{{y}_{2}} \times 100 , ... , \frac{\vert {y}_{i} - T ( \frac{{x}_{i}}{{x}_{min}} ) \vert}{{y}_{i}} \times 100 , \} ) \qquad Equation 71$$

$${}^{↑} {Error}_{max}^{- 1} = max ( \{ \frac{\vert {x}_{1} - {T}^{- 1} ( \frac{{y}_{1}}{{x}_{min}} ) \vert}{{x}_{1}} \times 100 , \\ \frac{\vert {x}_{2} - {T}^{- 1} ( \frac{{y}_{2}}{{x}_{min}} ) \vert}{{x}_{2}} \times 100 , ... , \frac{\vert {x}_{i} - {T}^{- 1} ( \frac{{y}_{i}}{{x}_{min}} ) \vert}{{x}_{i}} \times 100 , \} )$$

$${}^{↓} {Error}_{max} = max ( \{ \frac{\vert {y}_{1} - \frac{T ( {x}_{max} )}{T ( \frac{{x}_{1}}{{x}_{min}} )} \vert}{{y}_{1}} \times 100 , \\ \frac{\vert {y}_{2} - \frac{T ( {x}_{max} )}{T ( \frac{{x}_{2}}{{x}_{min}} )} \vert}{{y}_{2}} \times 100 , ... , \frac{\vert {y}_{i} - \frac{T ( {x}_{max} )}{T ( \frac{{x}_{i}}{{x}_{min}} )} \vert}{{y}_{i}} \times 100 , \} )$$

$${}^{↓} {Error}_{max}^{- 1} = max ( \{ \frac{\vert {x}_{1} - \frac{{T}^{- 1} ( {y}_{max} )}{{T}^{- 1} ( \frac{{y}_{1}}{{y}_{min}} )} \vert}{{x}_{1}} \times 100 , \\ \frac{\vert {x}_{2} - \frac{{T}^{- 1} ( {y}_{max} )}{{T}^{- 1} ( \frac{{y}_{2}}{{y}_{min}} )} \vert}{{x}_{2}} \times 100 , ... , \frac{\vert {x}_{i} - \frac{{T}^{- 1} ( {y}_{max} )}{{T}^{- 1} ( \frac{{y}_{i}}{{y}_{min}} )} \vert}{{x}_{i}} \times 100 , \} )$$

Where xᵢ=the ith value of x
yᵢ=the ith value of y

Note that if step 4c is encountered, a constant value is detected. If the constant value is zero then a perfect curve fit is indicated and there is no need for an Errorₘₐₓ calculation to be performed.

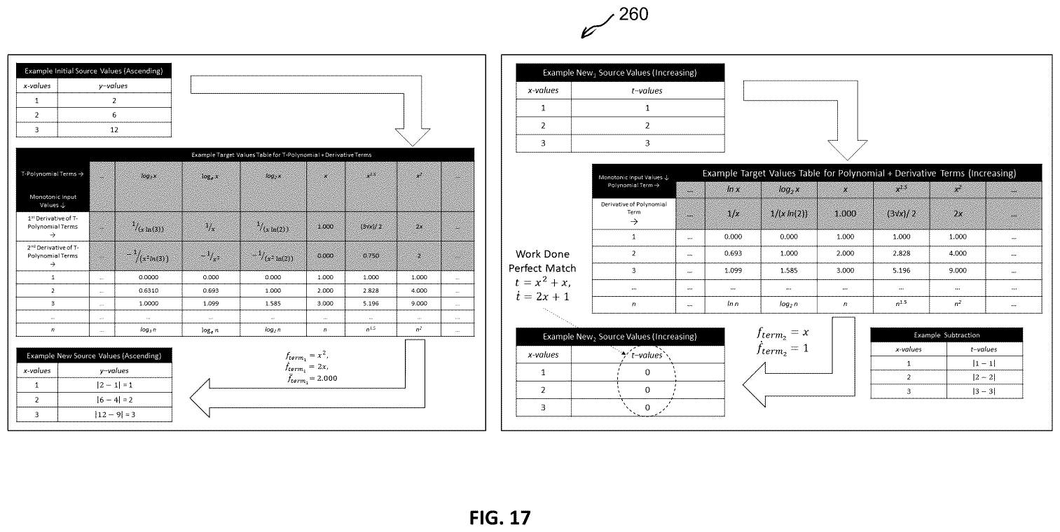

FIG. 17 shows, in tables 260, an example of the complete generation of a T-polynomial.

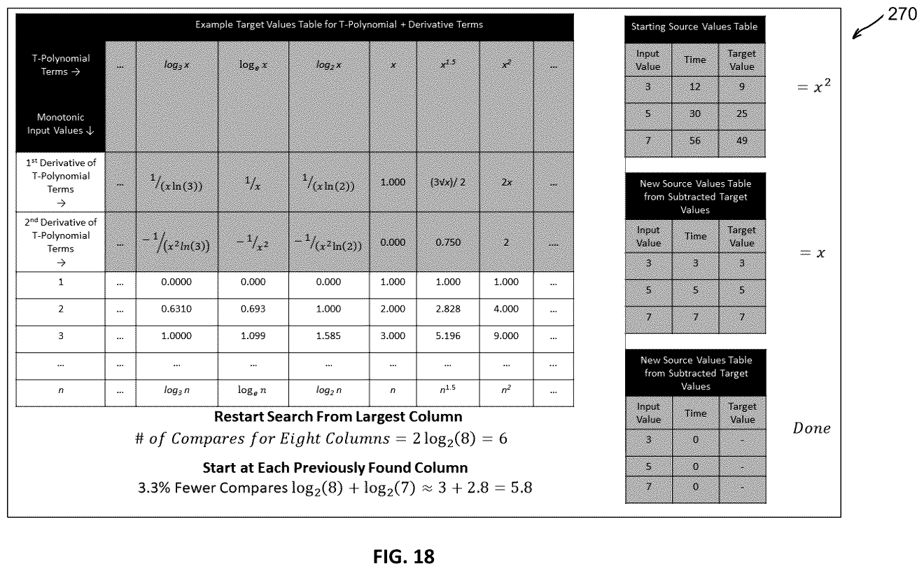

FIG. 18 shows, in tables 270, the expansion using a standard binary search compared to the present invention's advanced binary search method. Consider that the T-polynomial terms decrease as target table values are subtracted from the source table values. Because the target values table is sorted from smallest to largest term, when a term is found, larger terms in the table can be ignored. This means that as terms are found, fewer and fewer columns are required in the search for the next term. Decreasing the number of columns directly decreases the binary search requirements. This effect increases with the number of terms that need to be found, which for a T-polynomial means that larger order T-polynomials, because they can have more terms, typically see a greater effect using this method.

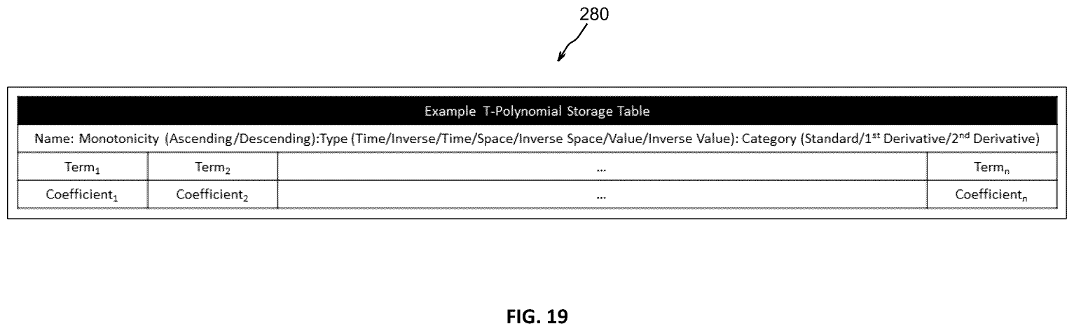

Table 280 of FIG. 19 shows an example format for storing the completed T-polynomial in a T-polynomial storage table.

### Single Variable Attribute Advanced Time Complexity

Advanced time complexity calculates time, either processing time or data movement time, given some input data variable, x, which represents an input variable attribute value that affects loop iterations (therefore, affects time) either in a calculation (changes input value without data movement) or in a data movement (changes data position in an array), or both. Input variables that affect time by affecting loop iterations are called herein temporal input variables.

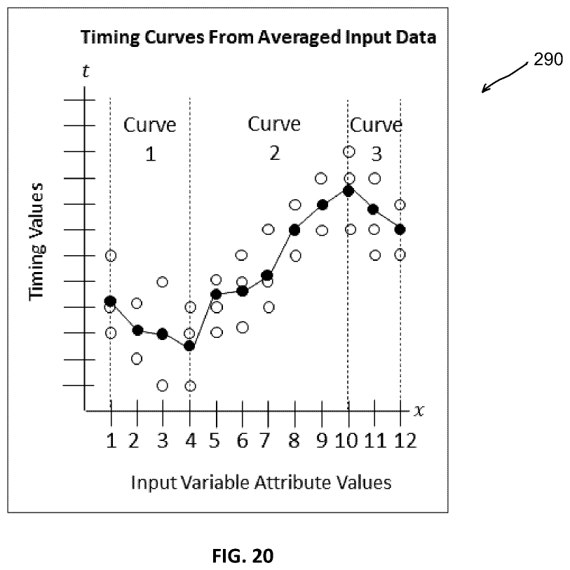

FIG. 20 shows, in graph 290, a timing curve formed from averaging data from a single input variable. It is possible generate prediction polynomials from averaged data or unaveraged data. Advanced single variable attribute time complexity is the ability to predict the processing time of a TALP or an OALP given some input attribute value that affects processing time (e.g., an input variable attribute that changes the number of loop iterations performed within either the TALP or OALP). An initial input variable attribute value, x, is gradually decreased and executed using a TALP or OALP, giving associated processing times, t. Those values can be placed into a table. The smallest input value in this finite set of values is called xₘᵢₙ. The smallest associated time values in this finite set of values is called tₘᵢₙ. A source values table can be generated by scaling the table values using the smallest values.

Comparing the source values table entries to the various extended target values table column entries is analogous to a curve fit. A standard method of performing a curve fit is to construct the best fit of a set of data points to either a line or a fixed non-linear curve. Finding the best fit is called a linear or non-linear least-square curve fit or more generally, a least-square curve fit. There are problems with least-square curve fits: first, it is a statistical method so that the more data points available, generally the more accurate the fit, and second, it attempts to fit the data to a single type of curve. There are many instances where the data is sparse, yet a prediction function is still required. The method herein only assumes that the data is monotonic or can be decomposed into two or more monotonic segments. Since a monotonic segment of data can be either continuously increasing or continuously decreasing, there are two methods shown herein: one for monotonically increasing and one for monotonically decreasing. Any list of data that is neither increasing nor decreasing is considered a constant. It should be noted that for large datasets, the values along the x-axis can be averaged, and the results used by the present invention.

Notice that the averaged values in FIG. 20 actually generate three monotonic curves: the first curve exists from 1 to 4 on the x axis, the second from 4 to 10, and the third curve from 10 to 12. In theory, instead of averaging, any measures of central tendency (mean, median, mode, etc.) could be used to combine a spread of values. Each of the monotonic curve segments will have a separate prediction polynomial. Since it takes all the separate prediction polynomials to represent the full curve, those prediction polynomials can be thought of as representing input data value ranges of a given TALP or OALP. A segment is selected for execution from the value range of the input variable attribute used to define the x axis. This means that both TALPs and OALPs could require multiple prediction polynomials, one for each monotonic curve segment.

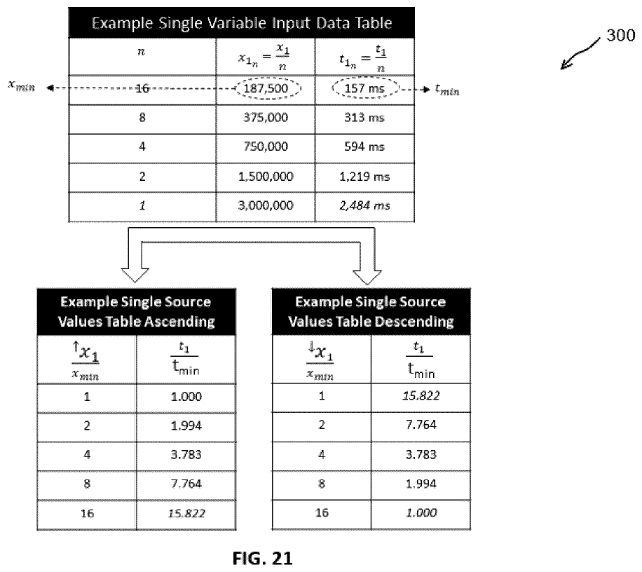

The table sets 300 of FIG. 21 show the conversion of raw data (data points on a timing curve) to ascending and descending source values table. Using timing input data, t, and the associated temporal input variable values, x, that affect loop iterations, the T-polynomial is generated by the aforementioned process using the extended target values table. The T-polynomial in combination with the minimum detected time value, tₘᵢₙ, and the original time units is used to find the advanced time complexity polynomial that approximates the time complexity function. Single variable attribute advanced time complexity is a prediction polynomial with the ability to predict the processing time of a TALP or an OALP given some input attribute value that affects time.

From the data in FIG. 21, the advanced time complexity prediction polynomial is shown in the equation below. It should be noted that the first derivative of advanced time complexity is processing time velocity and the second derivative is processing time acceleration.

$$Example of Advanced Time Complexity , First Form$$

$$t \times ms = time ( {x}_{1} ) \approx ( T ( \frac{{x}_{1}}{{x}_{min}} ) = a ) \times {t}_{min} \times ms = a \times 157 \times ms \qquad Equation 72$$

Like standard time complexity, advanced time complexity predicts the processing time for some temporal input value on a single processing element, x₁. Ascending advanced time complexity, herein called atime( ), is used when increasing the input variable attribute value that affects time increases how much time is required to perform a given task. For traditional time complexity, increasing the input dataset size increases the processing time of that dataset. Since both a magnitude and direction (ascending) is used, atime( ) represents a vector, making it substantially different from known conception of time complexity.

$$Q 1 Ascending Single Attribute Advanced Time Complexity , Standard Form$$

$$t \times ms \times Q {1}_{ascending} = atime ( {x}_{1} ) \approx T ( \frac{{x}_{1}}{{x}_{min}} ) \times {t}_{min} \times units \times Q {1}_{ascending} \qquad Equation 73$$

For advanced time complexity, time is always a positive value, as is the temporal input variable attribute, meaning it is always in the first quadrant. Thus, for advanced time complexity, only ascending or descending needs to be noted for the time vector, changing the equation to:

$$t \times ms \times ascending = atime ( {x}_{1} ) \approx T ( \frac{{x}_{1}}{{x}_{min}} ) \times {t}_{min} \times units \times ascending$$

The descending single attribute advanced time complexity, herein called dtime( ), is shown below.

$$Descending Single Attribute Advanced Time Complexity , Standard Form$$

$$t \times ms \times descending = dtime ( {x}_{1} ) \approx \frac{T ( {x}_{max} )}{T ( \frac{{x}_{1}}{{x}_{min}} )} \times {t}_{min} \times units \times descending \qquad Equation 74$$

The inverse of single attribute advanced time complexity calculates the temporal input variable attribute value, x, from a given time value, t, and is called herein itime( ), which gives a scalar value with units but no direction, making it a magnitude.

$$Inverse Single Attribute Advanced Time Complexity , First Form$$

$$x \times units = itime ( {t}_{1} ) \approx T ( \frac{{t}_{1}}{{t}_{min}} ) \times {x}_{min} \times units \qquad Equation 75$$

As with advanced time complexity, itime can have direction, making it a vector. Below shows the inverse ascending advanced time complexity, herein called aitime( ). Like advanced time complexity, aitime is always in the first quadrant.

$$Inverse Ascending Advanced Time Complexity , Standard Form$$

$$x \times units \times ascending = aitime ( {t}_{1} ) \approx T ( \frac{{t}_{1}}{{t}_{min}} ) \times {x}_{min} \times units \times ascending \qquad Equation 76$$

Inverse descending advanced time complexity, herein known as ditime also represents a vector and is always in the first quadrant.

$$Inverse Descending Advanced Time Complexity , Standard Form$$

$$x \times units \times descending = ditime ( {t}_{1} ) \approx \frac{T ( {t}_{max} )}{T ( \frac{{t}_{1}}{{t}_{min}} )} \times {x}_{min} \times units \times descending \qquad Equation 77$$

As previously discussed for prediction polynomials, the general form extends the ability of the advanced time complexity polynomial to the parallel execution of the TALP or OALP on multiple processing elements. Since the evenly spread temporal input attribute values give the same effect on each processing element, the general form of the time complexity prediction polynomial gives the per processing element effect. Since all processing elements take the same amount of processing time, calculating processing time, t, means calculating the time given the number of processing elements, n. When a TALP or OALP is executed on multiple processing elements, the amount of electrical power consumed when a computing system is processing a TALP or OALP is defined in the equation below.

W=n×(V×A)×t Equation 78 Power Consumption Prediction from Advanced Time Complexity, General Form
Where W=watts
n=number of processing elements
V=number of volts used per processing element per second
A=number of amps used per processing element per second
t=number of seconds

### Speedup

A key concept in computer science is that using multiple processing elements in parallel can only generate, at best, a linear performance gain, which is referred to as Amdahl's law. Amdahl's law uses three inputs to generate its performance prediction (speedup): serial time percentage (s=(1−p)), parallel time percentage (p), and the number of processing elements (n).

$${Amdahl}^{′} s Law$$

$$s = speedup ( n ) = \frac{{t}_{1}}{{t}_{n}} = \frac{1}{s + \frac{p}{n}} \qquad Equation 79$$

Where t₁=processing time given a single processing element,
   tₙ=processing time given n processing elements,
      p=parallel time,
         s=serial time,
      n=number of processing elements

It should be noted that standard Amdahl speedup is a scalar, unitless value that represents the magnitude of the processing time change. For use by OALPs, there are two problems with Amdahl's law. First, there is algorithmic incompatibility. That is, there are only input data attribute values, not the number of processing elements given as input for a standard algorithm. It was discovered that it is only the effect of the number of processing elements on the input data attribute values that is compatible with most algorithms, not the actual count of processing elements. The second problem is the derivation's change from processing time, t₁, and tₙ, to percentage of processing time (serial and parallel). Rather than converting from processing time to time percentage, TALPs and by extension OALPs are herein shown to use only t₁ and tₙ.

Advanced time complexity gives time as a function of some temporal input variable attribute value x. Time for some temporal input variable attribute value on a single processing element processing x can be designated tₓ_{₁} and time for the same temporal input variable attribute value on n processing elements can be designated tₓ_{ₙ}. The speedup function indicates how much faster an algorithm is executed on n processing elements compared to executing on a single processing element, that is, how much processing time decreases per processing element. Speedup herein is scaled advanced time complexity and a scalar, unitless value, a magnitude, like that shown for Amdahl speedup but allowing for non-linear solutions. Speedup is the T-polynomial of the advanced time complexity.

Speedup equals the scaled, unitless time value when T(n) equals a valid scaled, unitless temporal input variable attribute value. This makes speedup(n) a magnitude that indicates how much the processing time changes when an algorithm is executing on n processing elements versus on a single processing element.

$$Speedup as Scaled Unitless Advanced Time Complexity$$

$$s = speedup ( n ) = \frac{{t}_{1}}{{t}_{n}} = \frac{{t}_{{x}_{1}}}{{t}_{{x}_{n}}} = \frac{( \frac{{t}_{{x}_{1}}}{{t}_{{x}_{n}}} )}{( \frac{{t}_{{x}_{n}}}{{t}_{{x}_{n}}} )} \approx \frac{T ( \frac{{x}_{1}}{{x}_{n}} ) \times {t}_{min} \times ms \times ( ascending \vert descending )}{T ( \frac{{x}_{n}}{{x}_{n}} = 1 ) \times {t}_{min} \times ms \times ( ascending \vert descending )} = T ( \frac{{x}_{1}}{{x}_{n}} ) = T ( n ) ⇔ {x}_{n} \neq 0 \qquad Equation 80$$

It should be noted that if time remains unvaried for any x, then speedup(n)=1. It should also be noted that T(1)=1 for all real-valued polynomials whose coefficients and exponents are greater than or equal to one.

The form of a scaled, unitless ascending T-polynomial differs from the form of the scaled, unitless descending T-polynomial. Even though the direction, scale factor, and units are canceled when creating speedup, both the ascending and descending versions of speedup( ) are detectable from the form of the T-polynomial.

$$Ascending Speedup Definition$$

$$s \times ascending = aspeedup ( n ) = T ( \frac{{x}_{1}}{{x}_{min}} ) \times ascending = T ( n ) \times ascending \qquad Equation 81$$

$$Descending Speedup Definition$$

$$s \times descending = dspeedup ( n ) = \frac{T ( {x}_{max} )}{T ( \frac{{x}_{n}}{{x}_{min}} )} \times descending = T ( n ) \times descending \qquad Equation 82$$

Consider that like atime( ) and dtime( ), both aspeedup( ) and dspeedup( ) give both the scalar value (a magnitude) and a direction, ascending or descending. This makes aspeedup( ) and dspeedup( ) vectors, which is substantially different from the magnitude only values of Amdahl's speedup( ).

The inverse of speedup is called herein ispeedup and gives the number of processing elements, which is the same as the scaled temporal input values, from some input speedup value, which is scaled unitless processing time. Inverse speedup is the T-polynomial of the inverse advanced time complexity.

$$Inverse Speedup Using Scaled Unitless Temporal Input Attribute Values$$

$$processing elements = n = ispeedup ( s ) = \frac{( \frac{{x}_{1}}{{x}_{n}} )}{( \frac{{x}_{n}}{{x}_{n}} )} \approx \frac{T ( \frac{{t}_{1}}{{t}_{n}} ) \times {x}_{min} \times ms}{T ( 1 ) \times {x}_{min} \times ms} = T ( \frac{{t}_{1}}{{t}_{n}} ) = \frac{{x}_{1}}{{x}_{n}} ⇔ T ( 1 ) = 1 \& {t}_{n} \neq 0 \qquad Equation 83$$

As with speedup, there is both an ascending and a descending version of ispeedup.

$$Ascending Inverse Speedup$$

$$ascending processing elements = n \times ascending = aispeedup ( s ) \approx T ( \frac{{t}_{1}}{{t}_{n}} ) \times ascending \qquad Equation 84$$

$$Descending Inverse Speedup$$

$$descending processing elements = n \times descending = dispeedup ( s ) \approx \frac{T ( {t}_{max} )}{T ( \frac{( \frac{{t}_{1}}{{t}_{n}} )}{{t}_{min}} )} \times descending \qquad Equation 85$$

### Single Variable Attribute Advanced Space Complexity

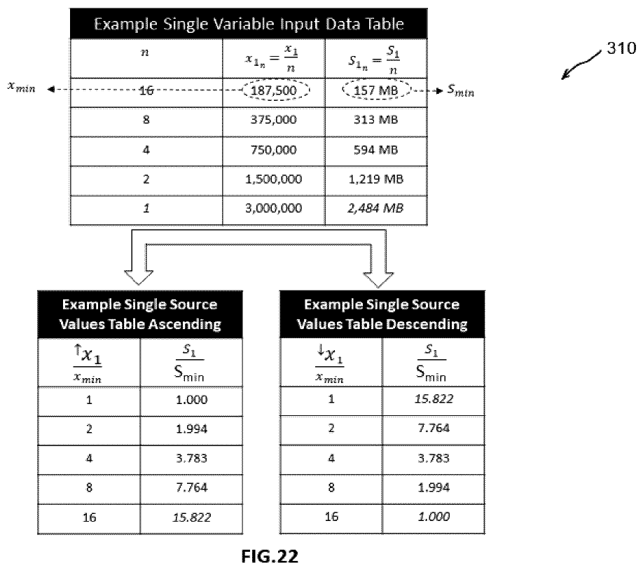

The table sets 310 of FIG. 22 show the conversion of raw data (data points on a spatial curve) to ascending and descending source values table. Using the output spatial data, S, and the associated spatial input variable values, x, that affect memory allocation, the T-polynomial is generated by the aforementioned process using the extended target values table. The T-polynomial in combination with the minimum detected spatial input value, xₘᵢₙ, and the original memory allocation units is used to find the advanced space complexity polynomial that approximates the space complexity function. Single variable attribute advanced space complexity is a prediction polynomial with the ability to predict memory allocation of a TALP or an OALP given some input attribute value that affects memory allocation (e.g., that changes the number of bytes in a malloc, calloc, etc., within either a TALP or an OALP). Such an input variable value is called a spatial input variable. It should be noted that the first derivative of advanced space complexity is memory allocation velocity and the second derivative is memory allocation acceleration.

From the data in FIG. 22, the advanced space complexity prediction polynomial is shown in the equation below.

$$Example of Advanced Space Complexity , First Form$$

$$S \times MB = space ( {x}_{1} ) \approx ( T ( \frac{{x}_{1}}{{x}_{min}} ) = a ) \times {S}_{min} \times MB = a \times 157 \times MB \qquad Equation 86$$

Advanced space complexity predicts the memory allocation for some spatial input value on a single processing element, x₁. This memory allocation is directionless and, therefore, only represents magnitude and a unit (e.g., megabytes). A spatial input data values-memory allocation graph used to generate advanced space complexity must be monotonic, either continuously ascending or continuously descending. Thus, it is possible to know not only the magnitude and units, but the direction as well.

The ascending single attribute advanced space complexity prediction polynomial, herein called aspace( ), is used when increasing the spatial input variable attribute value that affects memory allocation increases how much memory is required to perform a given task. For traditional space complexity, increasing the input dataset size increases the memory allocation of that dataset. Since both a magnitude and direction (ascending) is used, aspace( ) represents a vector, making it substantially different the conception of space complexity.

For advanced space complexity, space is always a positive value, as is the attribute that varies memory allocation, meaning it is always in the first quadrant. Thus, for advanced space complexity, only ascending or descending needs to be noted for the space vector.

$$Ascending Single Attribute Advanced Space Complexity , Standard Form$$

$$S \times MB \times ascending = aspace ( {x}_{1} ) \approx T ( \frac{{x}_{1}}{{x}_{min}} ) \times {S}_{min} \times units \times ascending \qquad Equation 87$$

The descending single attribute advanced space complexity, herein called dspace( ), is shown below.

$$Descending Single Attribute Advanced Space Complexity , Standard Form$$

$$S \times MB \times descending = dspace ( {x}_{1} ) \approx \frac{T ( {x}_{max} )}{T ( \frac{{x}_{1}}{{x}_{min}} )} \times {S}_{min} \times units \times descending \qquad Equation 88$$

The inverse of single attribute advanced space complexity calculates the spatial input variable attribute value, x, from a given memory allocation, S, and is called herein ispace( ), which gives a scalar value with units but no direction, making it a magnitude.

$$Inverse Single Attribute Advanced Space Complexity , First Form$$

$$x \times units = ispace ( {S}_{1} ) \approx T ( \frac{{S}_{1}}{{S}_{min}} ) \times {x}_{min} \times units \qquad Equation 89$$

As with advanced space complexity, inverse space complexity can have direction, making it a vector. Below shows the inverse ascending single attribute advanced space complexity, herein called aispace( ). Like advanced space complexity, aispace is always in the first quadrant.

$$Inverse Ascending Single Attribute Advanced Space Complexity , Standard Form$$

$$x \times units \times ascending = aispace ( {S}_{1} ) \approx T ( \frac{{S}_{1}}{{S}_{min}} ) \times {x}_{min} \times units \times ascending \qquad Equation 90$$

Inverse descending advanced space complexity equation, herein known as dispace( ) also represents a vector and is always in the first quadrant.

$$Inverse Descending Single Attribute Advanced Space Complexity , Standard Form$$

$$x \times units \times descending = dispace ( {S}_{1} ) \approx \frac{T ( {S}_{max} ) = 16}{T ( \frac{{S}_{1}}{{S}_{min}} ) = a} \times {x}_{min} \times units \times descending \qquad Equation 91$$

### Types of Advanced Space Complexity

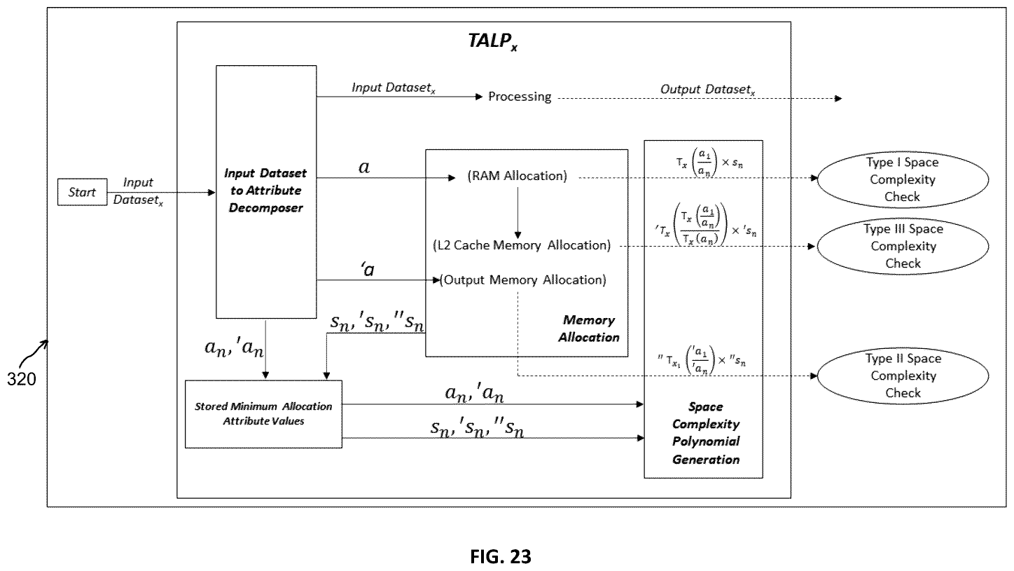

FIG. 23 depicts a block diagram 320 showing the generation of three different types of space prediction polynomials. Known space complexity for an algorithm is the required allocated random-access memory (RAM) given some input dataset size. This definition is limiting in its utility, given modern hardware. Instead of using the input dataset size, advanced space complexity uses a subset of the input variable attributes that affect memory allocation. There are three core space complexity functions for a TALP that are derived using these memory allocation-affecting input variable attributes.
1) Type I—Input variable attribute values that allocate RAM. Type I advanced space complexity subsumes the standard space complexity definition.
2) Type II—Input variable attribute values that allocate output memory.
3) Type III—Input variable attribute values that allocate L2 cache memory.

These space complexity functions can be extended to encompass as many levels of memory as required and can be calculated for both TALPs and OALPs.

Consider that memory allocation could be defined in the source code of some TALP as:
ALLOCATION (numberOfBytes);

The numberOfBytes could be some function of an input variable attribute a. For example:

numberOfBytes=a² Equation 92 Example Single Input Variable Attribute, Memory Allocation

One input variable attribute value that allocates memory followed by another allocation either from the same attribute or a different attribute has an additive relationship. In the following examples, w₁={a, b}.

### EXAMPLE

```
if {
    ALLOCATION(a²);
    ALLOCATION(b);
  }
then
  numberOfBytes = a² + b;
```

If the data types (e.g., integer, float, string, etc.) for which the memory is being allocated are the same then the amount of memory allocated is the sum of those allocations.

### EXAMPLE

```
if {
    ALLOCATION(a² + b);
  }
then
  numberOfBytes = a² + b;
```

Multiple input variable attributes interacting in the same allocation function give the number of bytes derived from that interaction.

### EXAMPLE

```
if {
    ALLOCATION(a² × b);
  }
then
  numberOfBytes = a² × b;
```

A memory allocation function can reside within a looping structure, which is comprised of one or more loops that encapsulate a block of code.

A loop has a multiplicative effect on an allocation function.

### Example 1

```
if {
    loop (starting value, ending value)
    {
      ALLOCATION(a²);
      ALLOCATION(b);
    }
  }
then
  numberOfBytes = |ending value − starting value| × (a² + b);
```

### Example 2

| if { | |
|---|---|
| loop (starting value1, ending value1) | |
| { | |
| Loop (starting value2, ending value2) | |
| { | |
| ALLOCATION(a²); | |
| ALLOCATION(b); | |
| } | |
| } | |
| } | |
| then | |
| numberOfBytes = | \|ending value1 − starting value1\| × |
| | \|ending value2 − starting value2\| × |
| | (a² + b); |

Multiple loop structures including memory allocation have an additive relationship with one another. In the following example, w₁={a, b, c, d}.

### EXAMPLE

```
if {
    loop (starting value1, ending value1)
    {
      ALLOCATION(a²);
      ALLOCATION(b);
    }
    loop (starting value 2, ending value2)
    {
      ALLOCATION(c);
      ALLOCATION(d);
    }
  }
then
```

| | |
|---|---|
| numberOfBytes = | \|ending value1 − starting value 1\| × (a² + b) + |
| | \|ending value2 − starting value 2\| × (c + d); |

These examples lead to the following rules for linking input variable attribute values that affect memory allocation (space) for a given TALP or OALP.

### Multiple Attribute Relationship Determination

1. The relationship between multiple input variable attributes used by a particular memory allocation function is the relationship found within that memory allocation function.
2. The relationship between the input variable attributes within multiple sequentially accessed memory allocation functions is additive.
3. The number of loop iterations is a multiplier for any contained memory allocation functions.
4. Multiple hierarchical loops that include a memory allocation function are multiplicatively associated both with each other and with the memory allocation function.
5. Multiple sequentially accessed loop structures that include memory allocation functions are additively associated.

The memory allocation of linked TALPs or OALPs can change the total memory allocation. There are two cases: unshared memory and shared memory allocation.

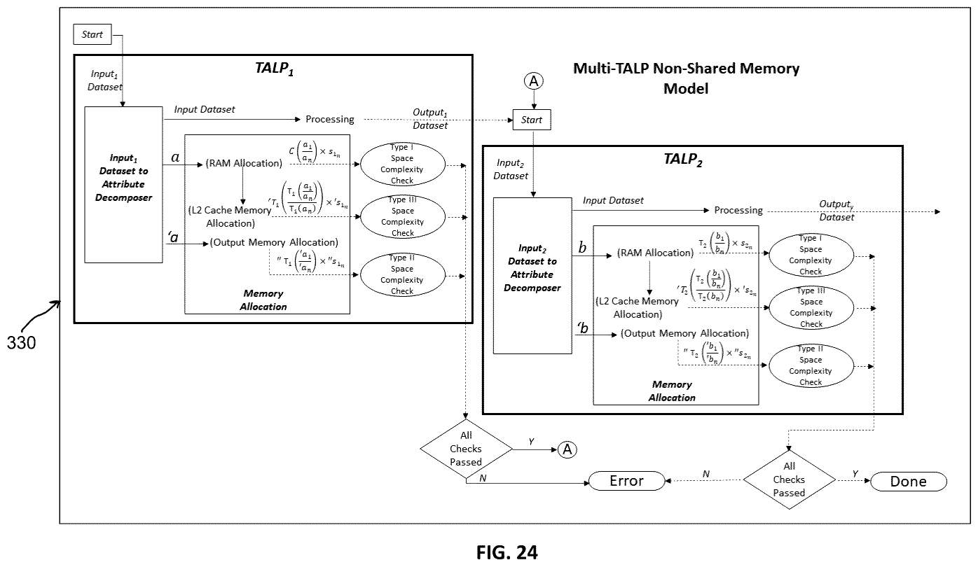

FIG. 24 depicts a block diagram 330 showing the memory effects from two linked TALPs or OALPs without a shared memory. With the unshared memory allocation model, two or more TALPs or OALPs are joined with the input of the succeeding TALP or OALP using some or all of the outputs of the preceding TALP or OALP. The memory of the preceding TALP or OALP is deallocated prior to the execution of the succeeding TALP or OALP, meaning that the maximum memory allocation equals the largest memory allocation of one of the linked TALPs or OALPs.

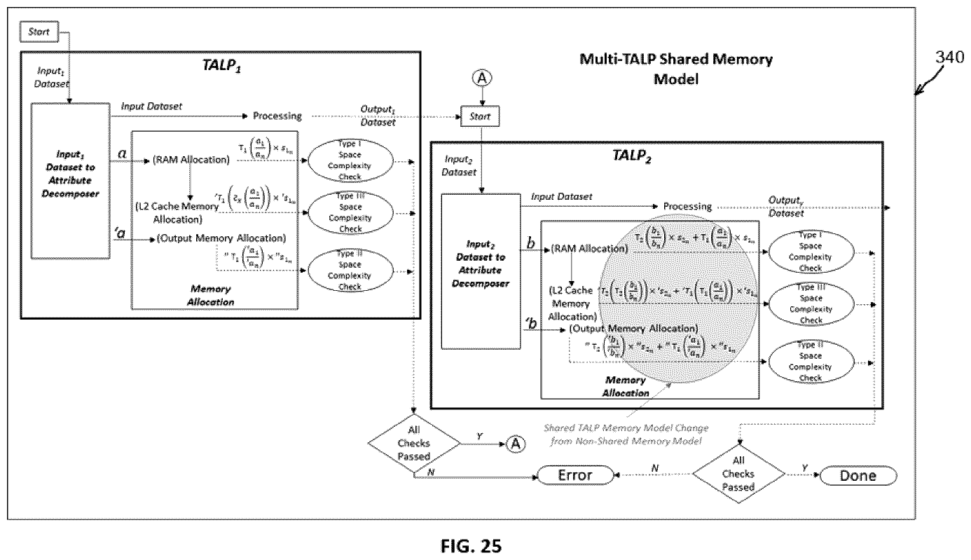

FIG. 25 shows a block diagram 340 of the effects on memory of two linked TALPs or OALPs with shared memory allocation. With the shared memory allocation model, two or more TALPs or OALPs are joined with the input of the succeeding using some or all of the outputs of the preceding TALP or OALP. The memory of the preceding TALP or OALP is not deallocated prior to the execution of the succeeding TALP or OALP, meaning that the maximum memory allocation is the sum of the memory allocations of the linked TALPs or OALPs. Note that the additive memory allocation between the linked TALPs is characterized here, not the additive memory that occurs within a TALP from multiple memory allocations within that same TALP.

Unlike time complexity, which is a prediction of a measurement (time), space complexity instead represents the allocation of a resource, that is, memory. Computer systems can have many allocatable resources, such as, the number of processing elements, display screens, servers (including groups of processing elements), and input/output channels. Like memory allocation, the allocation of these other resources can be tiered. For example, input/output channels could occur for chip-level communication (systems on a chip), single board-level communication, server-level communication, LAN communication, or WAN communication. If there is a set of input variable attributes that affect this allocation then a complexity function T-polynomial can be generated in a manner that is similar to how an advanced space complexity T-polynomial is generated. Any resource-based complexity function will behave analogously to advanced space complexity. Thus, resource complexity is an extension to advanced space complexity.

### Freeup

As previously stated, advanced space complexity gives memory allocation as a function of some spatial input variable attribute value x. Space for some spatial input variable attribute value on a single processing element can be designated Sₓ_{₁} and space for the same spatial input variable attribute value evenly distributed over n processing elements can be designated Sₓ_{ₙ}. The freeup function shows how much memory is freed when the processing is spread across n processing elements, that is, how much less memory is required per processing element. Like speedup, freeup is a magnitude, allowing for non-linear solutions. Freeup is scaled unitless advanced space complexity and, thus, the T-polynomial of the advanced space complexity.

Freeup equals the scaled, unitless memory allocation value when T(n) equals a valid scaled, unitless spatial input variable attribute value. This makes freeup(n) a magnitude that indicates how much the memory allocation changes when an algorithm is executing on n processing elements versus on a single processing element.

$$Freeup as Scaled Unitless Advanced Space Complexity$$

$$f = freeup ( n ) = \frac{{S}_{1}}{{S}_{n}} = \frac{{S}_{{x}_{1}}}{{S}_{{x}_{n}}} = \frac{( \frac{{S}_{{x}_{1}}}{{S}_{{x}_{n}}} )}{( \frac{{S}_{{x}_{n}}}{{S}_{{x}_{n}}} )} \approx \frac{T ( \frac{{x}_{1}}{{x}_{n}} ) \times {S}_{min} \times ms}{T ( \frac{{x}_{n}}{{x}_{n}} = 1 ) \times {S}_{min} \times ms} = T ( \frac{{x}_{1}}{{x}_{n}} ) = T ( n ) ⇔ T ( 1 ) = 1 \& {x}_{n} \neq 0 \qquad Equation 93$$

It should be noted that if space remains unvaried for any x, then freeup(n)=1. It should also be noted that T(1)=1 for all real-valued T-polynomials whose coefficients and exponents that are greater than or equal to one.

The form of a scaled, unitless ascending T-polynomial differs from the form of the scaled, unitless descending T-polynomial. Thus, even though the direction, scale factor, and units are canceled when creating freeup, both the ascending and descending versions of freeup( ) are detectable from the form of the T-polynomial. Both ascending and descending freeup are vectors.

$$Ascending Freeup Definition$$

$$f \times ascending = afreeup ( n ) = T ( \frac{{x}_{1}}{{x}_{n}} ) \times ascending = T ( n ) \times ascending \qquad Equation 94$$

$$Descending Freeup Definition$$

$$f \times descending = dfreeup ( n ) = \frac{T ( {x}_{max} )}{T ( \frac{{x}_{n}}{{x}_{min}} )} \times descending = T ( n ) \times descending \qquad Equation 95$$

The inverse of freeup is called herein ifreeup, which gives the number of processing elements, which is the same as the scaled spatial input values, from some input freeup value, which is scaled unitless space (memory allocation). Inverse freeup is scaled unitless inverse advanced space complexity and, thus, the T-polynomial of the inverse advanced space complexity.

$$Inverse Freeup Using Scaled Unitless Spatial Input Attribute Values$$

$$processing elements = n = ifreeup ( f ) = \frac{{x}_{1}}{{x}_{n}} = \frac{{x}_{{S}_{1}}}{{x}_{{S}_{n}}} = \frac{( \frac{{x}_{{S}_{1}}}{{x}_{{S}_{n}}} )}{( \frac{{x}_{{S}_{n}}}{{x}_{{S}_{n}}} )} \approx \frac{T ( \frac{{S}_{1}}{{S}_{n}} ) \times {x}_{min} \times unit}{T ( \frac{{S}_{n}}{{S}_{n}} = 1 ) \times {x}_{min} \times ms} = T ( \frac{{S}_{1}}{{S}_{n}} ) = T ( f ) ⇔ T ( 1 ) = 1 \& {x}_{n} \neq 0 \qquad Equation 96$$

There is both an ascending and a descending version of ifreeup called aifreeup and difreeup.

$$Ascending Inverse Freeup$$

$$n \times a scending = aifreeup ( f ) \approx T ( \frac{{S}_{1}}{{S}_{n}} ) \times a scending = T ( f ) \times a scending \qquad Equation 97$$

$$Descending Inverse Freeup$$

$$n \times descending = difreeup ( f ) \approx \frac{T ( {S}_{max} )}{T ( \frac{{S}_{n}}{{S}_{min}} )} \times descending \qquad Equation 98$$

### Single Variable Attribute Output Complexity

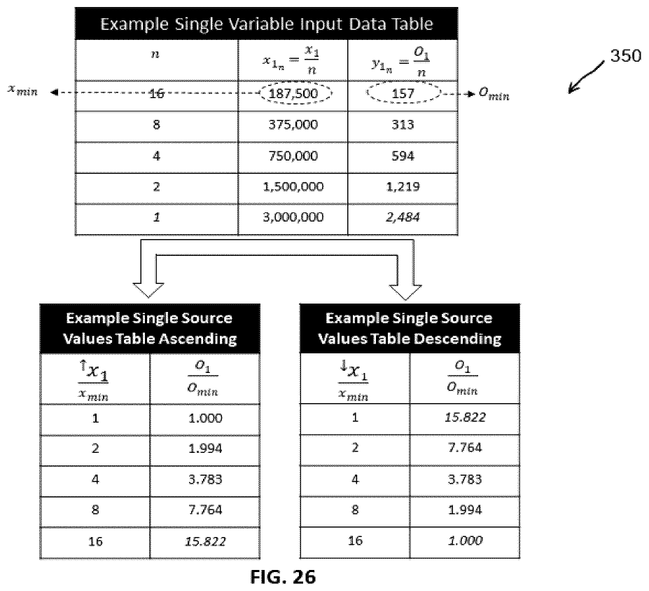

The table sets 350 of FIG. 26 show source values tables constructed for both ascending and descending curves by scaling the values from a single variable input data table using the data points of an output data curve. Input variable attribute values that affect TALP/OALP output values, x, and their associated output values, O, are placed into the single variable input data table. The smallest input value in the finite set of values is called xₘᵢₙ. The smallest associated output value in the finite set of values is called, Oₘᵢₙ. A source values table can be generated by scaling the values using the minimum values. Since the O value is output and the x values are input variable attribute values that affect the output, the result can represent either a single attribute ascending or a single attribute descending T-polynomial. It should be noted that the first derivative of output complexity is velocity of output processing and the second derivative is acceleration of output processing.

Once a single source values table has been created from the scaled input data that affect an algorithm's output values (not processing time or memory allocation), it can be used to generate a T-polynomial. The T-polynomial in combination with the minimum detected output value is used to find the output complexity polynomial that approximates the output complexity function. Single variable attribute output complexity is the ability to predict the output values of a TALP or an OALP given some input attribute value that affects output values. Using the data from FIG. 26, the output complexity prediction polynomial is shown in the following equation.

$$Example of Output Complexity , First Form$$

$$O = output ( {x}_{1} ) \approx ( T ( \frac{{x}_{1}}{{x}_{min}} ) = a ) \times {O}_{min} = a \times 157 \qquad Equation 99$$

Unlike advanced time or advanced space complexity, output complexity can use or generate values from and/or to any of the quadrants.

Because the monotonic curves discussed herein for output complexity are finite, the standard form for an ascending output complexity prediction polynomial must have a range of input values with definitive starting and ending values: xₘᵢₙ and xₘₐₓ.

$$Q 1 Ascending Single Attribute Output Complexity , Standard Form$$

$$O \times Q {1}_{ascending} = aoutput ( {x}_{1} ) = T ( \frac{{x}_{1}}{{x}_{min}} ) \times {O}_{min} \times Q {1}_{ascending} \qquad Equation 100$$

The same output complexity polynomial in quadrant 2 is detectable when the input variable value is negative and the output value is positive.

$$Q 2 Ascending Single Attribute Output Complexity , Standard Form$$

$$O \times Q {2}_{ascending} = aoutput ( - {x}_{1} ) = T ( \frac{\vert - {x}_{1} \vert}{{x}_{min}} ) \times {O}_{min} \times Q {2}_{ascending} \qquad Equation 101$$

The same output complexity polynomial in quadrant 3 is detectable when the input variable value is negative and the output value is also negative, and in quadrant 4 when the input variable value is positive and the output value is negative.

$$Q 3 Ascending Single Attribute Output Complexity , Standard Form$$

$$- O \times Q {3}_{ascending} = - aoutput ( - {x}_{1} ) = - T ( \frac{\vert - {x}_{1} \vert}{{x}_{min}} ) \times {O}_{min} \times Q {3}_{ascending} \qquad Equation 102$$

$$Q 4 Ascending Single Attribute Output Complexity , Standard Form$$

$$- O \times Q {4}_{ascending} = - aoutput ( {x}_{1} ) = - T ( \frac{{x}_{1}}{{x}_{min}} ) \times {O}_{min} \times Q {4}_{ascending} \qquad Equation 103$$

To achieve the descending output complexity affect, the input value must be manipulated as shown in Equations 104 through 107.

$$Q 1 Descending Single Attribute Output Complexity , Standard Form$$

$$O \times Q {1}_{descending} = doutput ( {x}_{1} ) = \frac{T ( {x}_{max} )}{T ( \frac{{x}_{1}}{{x}_{min}} )} \times {O}_{min} \times Q {1}_{descending} \qquad Equation 104$$

$$Q 2 Descending Single Attribute Output Complexity , Standard Form$$

$$O \times Q {2}_{descending} = doutput ( - {x}_{1} ) = \frac{T ( {x}_{max} )}{T ( \frac{\vert - {x}_{1} \vert}{{x}_{min}} )} \times {O}_{min} \times {Q2}_{descending} \qquad Equation 105$$

$$Q 3 Descending Single Attribute Output Complexity , Standard Form$$

$$- O \times Q {3}_{descending} = - doutput ( - {x}_{1} ) = - \frac{T ( {x}_{max} )}{T ( \frac{\vert - {x}_{1} \vert}{{x}_{min}} )} \times {O}_{min} \times Q {3}_{descending} \qquad Equation 106$$

$$Q 4 Descending Single Attribute Output Complexity , Standard Form$$

$$- O \times Q {4}_{descending} = - doutput ( {x}_{1} ) = - \frac{T ( {x}_{max} )}{T ( \frac{{x}_{1}}{{x}_{min}} )} \times {O}_{min} \times Q {4}_{descending} \qquad Equation 107$$

The inverse of single attribute output complexity calculates the output-affecting input variable attribute value, x, from a given an algorithm's output value, y, and is called herein ioutput( ), which gives a scalar value with units but no direction, making it a magnitude. Since TALP and OALP input and output variable attribute values can be calculated, this means that executable TALPs and OALPs can be considered reversible. A given set of TALP or OALP output variable attribute values is used to calculate the set of TALP or OALP input variable attribute values.

$$Inverse Output Complexity , First Form$$

$${x}_{1} = ioutput ( {O}_{1} ) \approx T ( \frac{{O}_{1}}{{O}_{min}} ) \times {x}_{min} \qquad Equation 108$$

As with output complexity, inverse output complexity can have direction, making it a vector. Below shows the single attribute ascending inverse output complexity, herein called aioutput. Unlike advanced time or advanced space complexity, inverse output complexity can use or generate values from and/or to any of the quadrants.

$$Q 1 Inverse Ascending Single Attribute Output Complexity , Standard Form$$

$$x \times Q {1}_{ascending} = aioutput ( {O}_{1} ) = T ( \frac{{O}_{1}}{{O}_{min}} ) \times {x}_{min} \times Q {1}_{ascending} \qquad Equation 109$$

$$Q 2 Inverse Ascending Single Attribute Output Complexity , Standard Form$$

$$- x \times Q {2}_{ascending} = - aioutput ( {O}_{1} ) = - T ( \frac{{O}_{1}}{{O}_{min}} ) \times {x}_{min} \times Q {2}_{ascending} \qquad Equation 110$$

$$Q 3 Inverse Ascending Single Attribute Output Complexity , Standard Form$$

$$- x \times Q {3}_{ascending} = - aioutput ( - {O}_{1} ) = - T ( \frac{\vert - {O}_{1} \vert}{{O}_{min}} ) \times {x}_{min} \times Q {3}_{ascending} \qquad Equation 111$$

$$Q 4 Inverse Ascending Single Attribute Output Complexity , Standard Form$$

$$x \times Q {4}_{ascending} = aioutput ( - {O}_{1} ) = T ( \frac{\vert - {O}_{1} \vert}{{O}_{min}} ) \times {x}_{min} \times Q {4}_{ascending} \qquad Equation 112$$

The descending inverse output complexity equation, herein known as dioutput, also represents a vector.

$$Q 1 Inverse Descending Single Attribute Output Complexity , Standard Form$$

$$x \times Q {1}_{descending} = dioutput ( {O}_{1} ) = \frac{T ( {O}_{max} )}{T ( \frac{{O}_{1}}{{O}_{min}} )} \times {x}_{min} \times Q {1}_{descending} \qquad Equation 113$$

$$Q 2 Inverse Descending Single Attribute Output Complexity , Standard Form$$

$$- x \times Q {2}_{descending} = - dioutput ( {O}_{1} ) = - \frac{T ( {O}_{max} )}{T ( \frac{{O}_{1}}{{O}_{min}} )} \times {x}_{min} \times Q {2}_{descending} \qquad Equation 114$$

$$Q 3 Inverse Descending Single Attribute Output Complexity , Standard Form$$

$$- x \times Q {3}_{descending} = - dioutput ( - {O}_{1} ) = - \frac{T ( {O}_{max} )}{T ( \frac{\vert - {O}_{1} \vert}{{O}_{min}} )} \times {x}_{min} \times Q {3}_{descending} \qquad Equation 115$$

$$Q 4 Inverse Descending Single Attribute Output Complexity , Standard Form$$

$$- x \times Q {4}_{descending} = - dioutput ( {O}_{1} ) = - \frac{T ( {O}_{max} )}{T ( \frac{{O}_{1}}{{O}_{min}} )} \times {x}_{min} \times Q {4}_{descending} \qquad Equation 116$$

### Divvyup

As previously stated, output complexity gives the algorithm's output values generated by a TALP or OALP as a function of some input variable attribute value x that affects output values. Output for some output value-affecting input variable attribute value on a single processing element can be designated Oₓ_{₁} and output for the same input variable attribute value evenly distributed over n processing elements can be designated Oₓ_{ₙ}. The divvyup function shows how the output is affected by the input that has been spread evenly across n processing elements, that is, the decrease in size and/or values of the output generated per processing element. Divvyup gives a scaled unitless value and, thus, is the T-polynomial of the output complexity.

Divvyup equals the scaled, unitless output value when T(n) equals a valid scaled, unitless output-affecting input variable attribute value. This makes divvyup(n) a magnitude that indicates how much the output changes when an algorithm is executing on n processing elements versus on a single processing element.

$$Divvyup as Scaled Unitless Output Complexity$$

$$D = divvyup ( n ) = \frac{{x}_{1}}{{x}_{n}} = \frac{{O}_{{x}_{1}}}{{O}_{{x}_{n}}} = \frac{( \frac{{O}_{{x}_{1}}}{{O}_{{x}_{n}}} )}{( \frac{{O}_{{x}_{n}}}{{O}_{{x}_{n}}} )} \approx \frac{T ( \frac{{x}_{1}}{{x}_{n}} ) \times {O}_{min} \times ascending \times descending}{T ( \frac{{x}_{n}}{{x}_{n}} = 1 ) \times {O}_{min} \times ascending \times descending} = T ( \frac{{x}_{1}}{{x}_{n}} ) = T ( n ) \qquad Equation 117$$

The form of a scaled, unitless ascending T-polynomial differs from the form of the scaled, unitless descending T-polynomial. Thus, even though the direction, scale factor, and units are canceled when creating divvyup, both the ascending and descending versions of divvyup( ) are detectable from the form of the T-polynomial. Unlike speedup or freeup, divvyup(n) gives a scalar, unitless, magnitude value that allows for non-linear solutions in any quadrant.

$$Q 1 Ascending Single Attribute Divvyup$$

$$D \times Q {1}_{ascending} = adivvyup ( n ) = T ( \frac{{x}_{1}}{{x}_{n}} ) \times Q {1}_{ascending} = T ( n ) \times Q {1}_{ascending} \qquad Equation 118$$

$$Q 2 Ascending Single Attribute Divvyup$$

$$D \times Q {2}_{ascending} = adivvyup ( - n ) = T ( \frac{\vert - {x}_{1} \vert}{{x}_{n}} ) \times Q {2}_{ascending} = T ( \vert - n \vert ) \times Q {2}_{ascending} \qquad Equation 119$$

$$Q 3 Ascending Single Attribute Divvyup$$

$$- D \times Q {3}_{ascending} = - adivvyup ( - n ) = - T ( \frac{\vert - {x}_{1} \vert}{{x}_{n}} ) Q {3}_{ascending} = - T ( \vert - n \vert ) Q {3}_{ascending} \qquad Equation 120$$

$$Q 4 Ascending Single Attribute Divvyup$$

$$- D \times Q {4}_{ascending} = - adivvyup ( n ) = - T ( \frac{{x}_{1}}{{x}_{n}} ) \times Q {4}_{ascending} = - T ( n ) \times Q {4}_{ascending} \qquad Equation 121$$

$$Q 1 Descending Single Attribute Divvyup$$

$$D \times Q {1}_{descending} = ddivvyup ( n ) = \frac{T ( {x}_{max} )}{T ( \frac{{x}_{1}}{{x}_{n}} )} \times Q {1}_{descending} = \frac{T ( {x}_{max} )}{T ( n )} \times Q {1}_{descending} \qquad Equation 122$$

$$Single Q 2 Descending Single Attribute Divvyup$$

$$D \times Q {2}_{descending} = ddivvyup ( - n ) = \frac{T ( {x}_{max} )}{T ( \frac{\vert - {x}_{1} \vert}{{x}_{n}} )} \times Q {2}_{descending} = \frac{T ( {x}_{max} )}{T ( \vert - n \vert )} \times Q {2}_{descending} \qquad Equation 123$$

$$Q 3 Descending Single Attribute Divvyup$$

$$- D \times Q {3}_{descending} = - ddivvyup ( - n ) = - \frac{T ( {x}_{max} )}{T ( \frac{\vert - {x}_{1} \vert}{{x}_{n}} )} \times Q {3}_{descending} = - \frac{T ( {x}_{max} )}{T ( \vert - n \vert )} \times Q {3}_{descending} \qquad Equation 124$$

$$Q 4 Descending Single Attribute Divvyup$$

$$- D \times Q {4}_{descending} = - ddivvyup ( n ) = - \frac{T ( {x}_{max} )}{T ( \frac{{x}_{1}}{{x}_{n}} )} \times Q {4}_{descending} = \frac{T ( {x}_{max} )}{T ( n )} \times Q {4}_{descending} \qquad Equation 125$$

The inverse of divvyup is called herein idivvyup, which gives the number of processing elements. Inverse divvyup is scaled unitless inverse output complexity and, thus, the T-polynomial of the inverse output complexity. Like divvyup, idivvyup has ascending and descending forms for each quadrant.

### Multi-Variable Attribute T-Polynomials for Advanced Time, Advance Space, and Output Complexity

The multiple input variable attributes of a TALP, each of which is associated with an OALP of that TALP, can be used to generate multiple T-polynomials, one for each prediction polynomial (analytic). Because each OALP is associated with a single input variable attribute, regardless of whether it affects time, space and/or output values, the OALPs can be simultaneously executed to find their T-polynomials. More than one T-polynomial can be associated with an OALP because its input variable attribute values can affect more than one analytic. The T-polynomials from all OALPS generated for each analytic are combined to form the complete analytics for the TALP.

Consider, for example, that the looping structure of a TALP can be controlled using multiple input variable attribute values that affect time. Since variable time changes with the number of loop iterations, it is possible to find the loop iteration effects for each of the responsible input variable attributes by executing the OALPs associated with a TALP and constructing a source values table for each OALP.

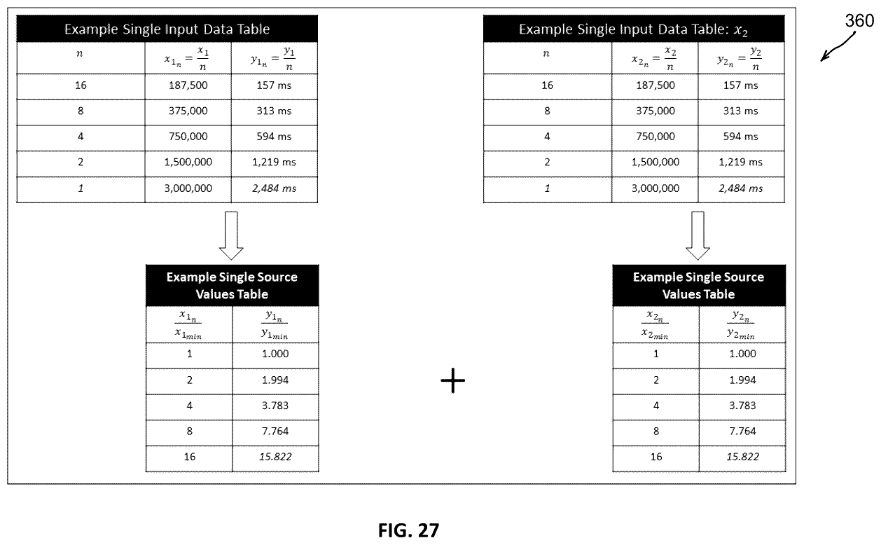

The table sets 360 of FIG. 27 show an example of an additive relationship between the input variable attribute values of two OALPs. The relationship between the single input variable attribute values of the OALPs is constructed from an examination of the control of the looping structures of the TALP.

Once the source values tables have been created for both x₁ and x₂ from the input data, the tables can be used to generate the T-polynomials of the individual OALPs. Because there is an additive relationship within the loop control of the TALP, the two advanced time complexity prediction polynomials, constructed using the T-polynomials found using the source values table data of the individual OALPs, are summed, giving the complete ascending multi-attribute advanced time complexity.

$$Example of Ascending Multi - Attribute Advanced Time Complexity$$

$$atime ( {x}_{1} , {x}_{2} ) = ( ( ( T ( \frac{{x}_{1}}{{x}_{{1}_{min}}} ) = {a}_{1} ) \times {t}_{{1}_{min}} \times ms ) + ( ( T ( \frac{{x}_{2}}{{x}_{{2}_{min}}} ) = {a}_{2} ) \times {t}_{{2}_{min}} \times ms ) ) \times ascending = ( ( {a}_{1}^{2} \times {t}_{{1}_{min}} ) + ( {a}_{2}^{2} \times {t}_{{2}_{min}} ) ) \times ms \times ascending = ( {a}_{1}^{2} + {a}_{2}^{2} ) \times 157 \times ms \times ascending \qquad Equation 126$$

Descending advanced time complexity equations can also be created.

$$Example of Descending Multi - Attribute Advanced Time Complexity$$

$$dtime ( {x}_{1} , {x}_{2} ) = ( ( \frac{T ( {x}_{{1}_{max}} )}{T ( \frac{( \frac{{x}_{1}}{{n}_{1}} )}{{x}_{{1}_{min}}} ) = a} \times {t}_{{1}_{min}} \times ms ) + ( ( \frac{T ( {x}_{{2}_{max}} )}{T ( \frac{( \frac{{x}_{2}}{{n}_{2}} )}{{x}_{{2}_{min}}} ) = a} \times {t}_{{2}_{min}} \times ms ) ) \times descending = ( \frac{16}{a} + \frac{16}{a} ) \times ms \times descending = ( \frac{16}{a} + \frac{16}{a} ) \times 157 \times ms \times descending \qquad Equation 127$$

Since the output of an analytic is the predicted time, space or output value and sensitivity is determined by comparing the effect of each input variable value on the set of output variable values, the sensitivity of each analytic of a TALP can be determined. Consider that each OALP allows only a single input variable value to be varied while automatically holding all other input variable values constant. Calculating the sensitivity of an analytic to its input variables means comparing the effects of the impact of each input variable on the output of the analytic of the TALP and is used to determine which input variable is most important to the analytic. Alternatively, a specific prediction polynomial (analytic) of all of the OALPs of the TALP can be compared, with the largest being the one with the greatest impact and, thus, giving the input variable with the greatest impact.

### Linked TALP Start Time Constraints

There can be delays to starting the execution of a TALP. Those delays can propagate through multiple linked TALPs and affect the total processing time of those linked TALPs. As discussed above, advanced time complexity is used to calculate the processing time of an associated TALP. Given a scheduled execution start time for a TALP and the predicted processing time of that TALP, a processing completion time, called end time, can be calculated.

endTime×units=startTime+time(x₁) Equation 128 End Time Definition

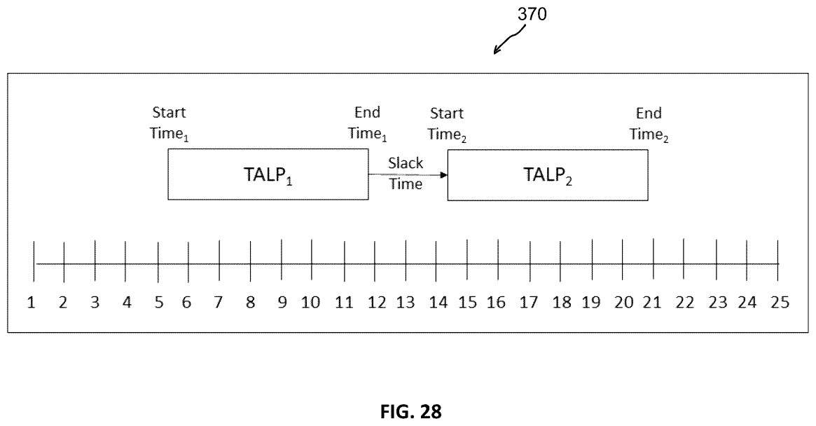

FIG. 28 shows an example diagram 370 of two TALPs each with an expected start time and a calculated end time, separated by a delay period called slack time. The length of slack time can vary depending on the actual start time and end time of the first TALP. The purpose of slack time is to ensure that the total time of the linked TALPs is fixed; that is, the end time of the second TALP remains as expected even if the start time of the first TALP is delayed. The end time of the second TALP will only be delayed if the start time of the first TALP is delayed by an amount of time greater than the slack time.

There are also linked TALP start time constraints based on the availability of input variable attribute values. A scheduled start time can be delayed if not all required input variable attribute values are not available. The use of slack time in this case is used to allow for delays in the receipt of the required input variable attribute values. Linked TALP start time constraints have applications in both scheduling and logistics.

### Automatic Extended Target Values Table Column Growth

The present invention uses an extended target values table with multiple columns that are searched to build T-polynomials. The number of columns, which consist of polynomial terms and their calculated scaled term values, can be extended.

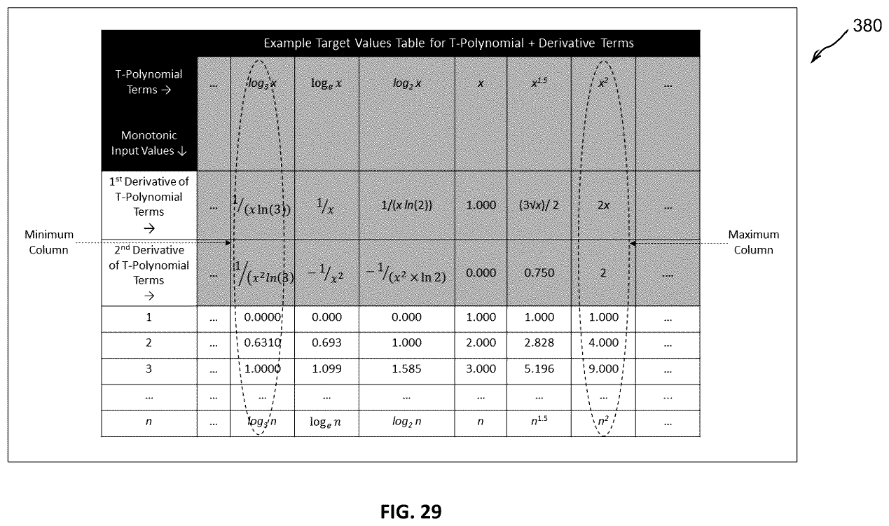

FIG. 29 shows an example table 380 of the minimum and maximum values of an example target values table highlighted. There are always minimum and maximum value columns within an extended target values table.

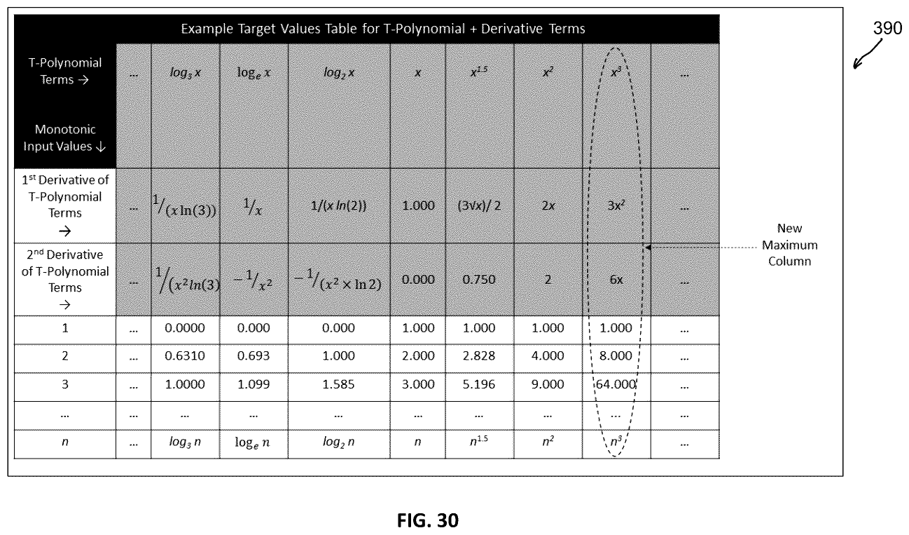

FIG. 30 shows an example table 390 of the extension of the example target values table by adding a new maximum column. If the output values of the source values table are larger than the associated extended target values table's maximum column values, then a new column is added to the extended target values table. This new column becomes the new maximum column.

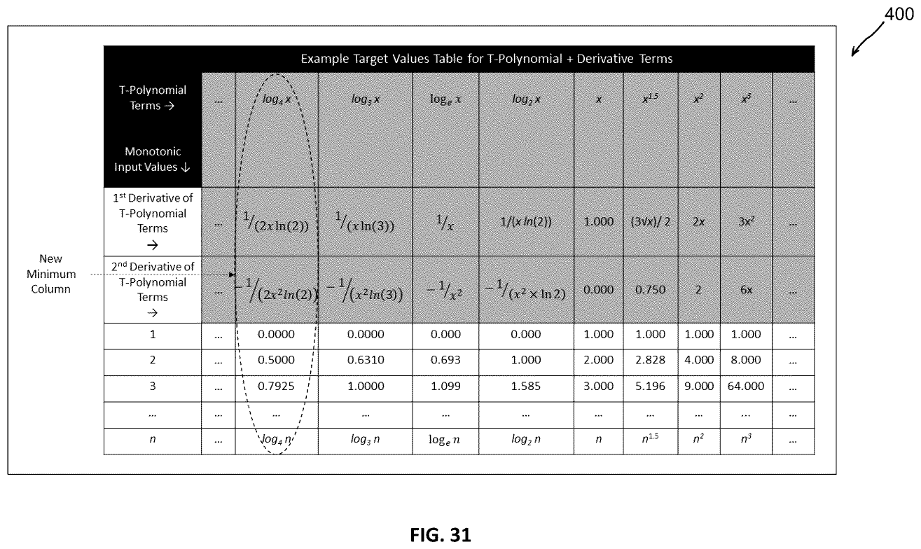

FIG. 31 shows an example table 400 that if the output values of the source values table are smaller than the associated extended target values table's minimum column values, then a new column is added to the extended target values table as the new minimum column.

A new term can be added between the minimum and maximum columns as needed by adding the terms of two adjacent columns and dividing by two. If the maximum error of a found T-polynomial exceeds the required maximum error, then new columns are added between the column of each found term in the failed T-polynomial and the next higher column.

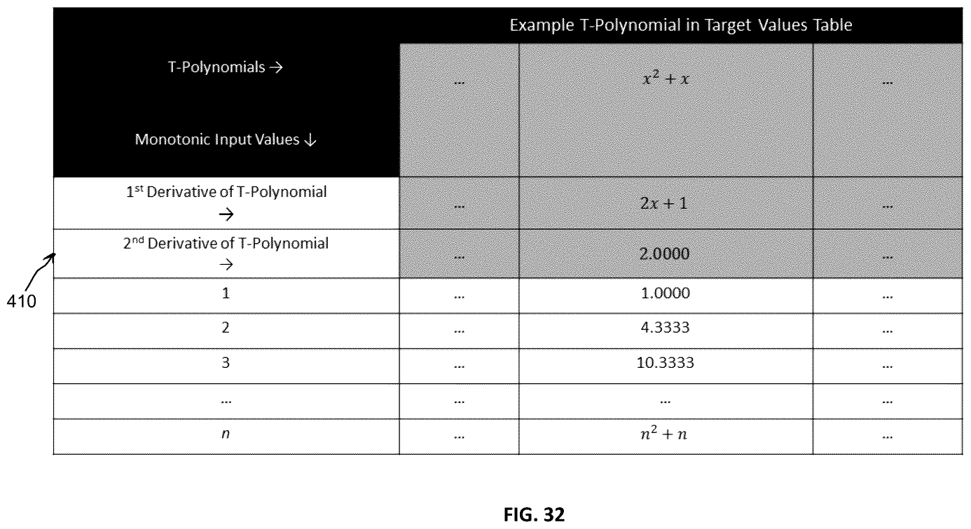

FIG. 32 shows an example table 410 of a multi-term column to be added to a new multi-term target values table. Each T-polynomial generated using the extended target values table is saved as a new column in a new multi-term target values table. Each T-polynomial can then be found with one search in the future, not the multiple searches that were originally required to build it.

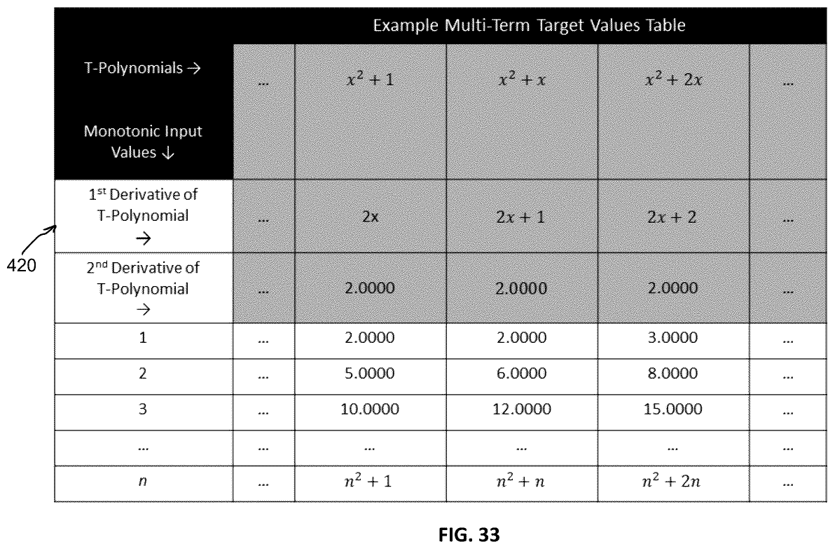

FIG. 33 shows an example table 420 of multiple T-polynomials in a multi-term target values table sorted from the smallest to the largest as with the extended target values table. Additional T-polynomials are added to the multi-term target values table in the same way single terms are added to the extended target values table.

There are many types of machine learning. The automatic creation of the extended target values table and the multi-term target values target are examples of machine learning.

### Hypothesis Generation

Consider that output complexity relates some set of output-affecting input variable attribute values to some set of output variable attribute values. Given a set of such input variable attributes that are detected by sensor, the relationship between an input variable attribute and the sensor reading, the output complexity, can be determined. Input variables that are not directly detected by the sensor can still affect the sensor readings are herein called context variables. Changes in the context variable values can affect the sensor reading even when the sensor does not directly detect the context variable values. The context output complexity per context is found by finding the difference between the output complexity from sensor detections with a constant context and the output complexity from sensor detections with a variable context.

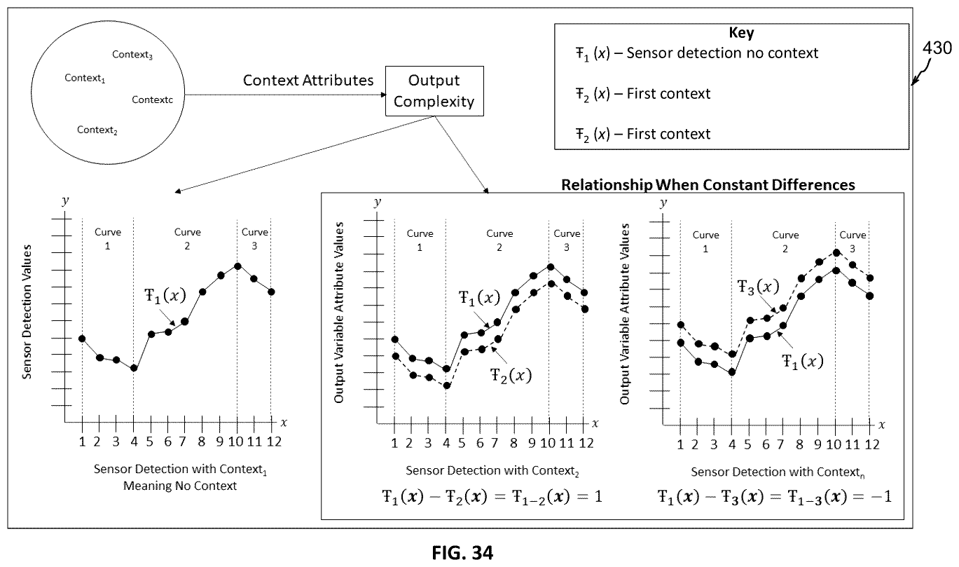

FIG. 34 depicts a diagram 430 showing a comparison between the output complexity of sensor detections without context variables and the output complexity with context variables that are constant. It is possible to have the relationship of a context variable to sensor detection as a constant. If the constant relationship value between a sensor detection with a context variable is within some epsilon of zero then it is considered to not have an effect on the sensor reading.

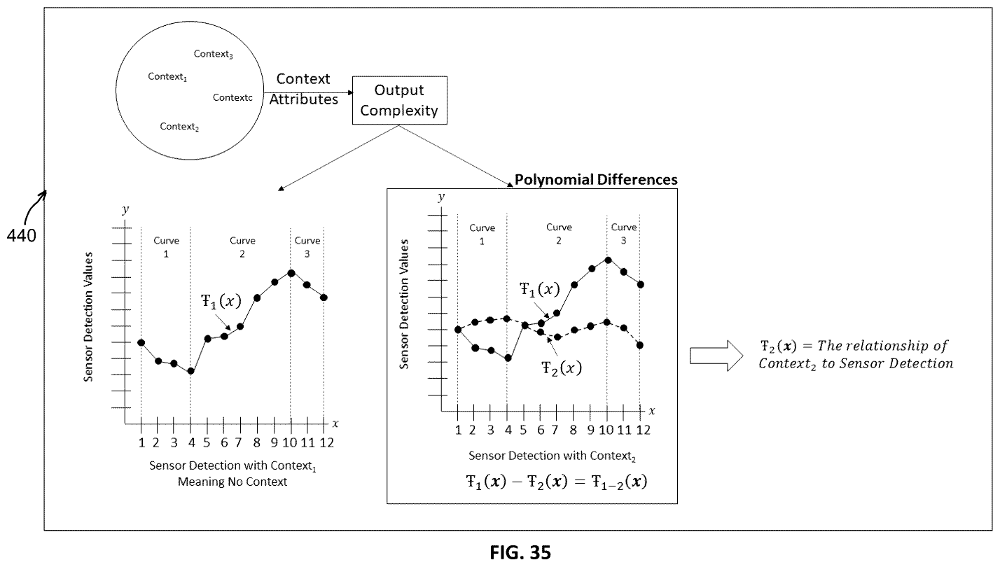

FIG. 35 depicts a diagram 440 showing the output complexity of sensor detection with and without variable context.

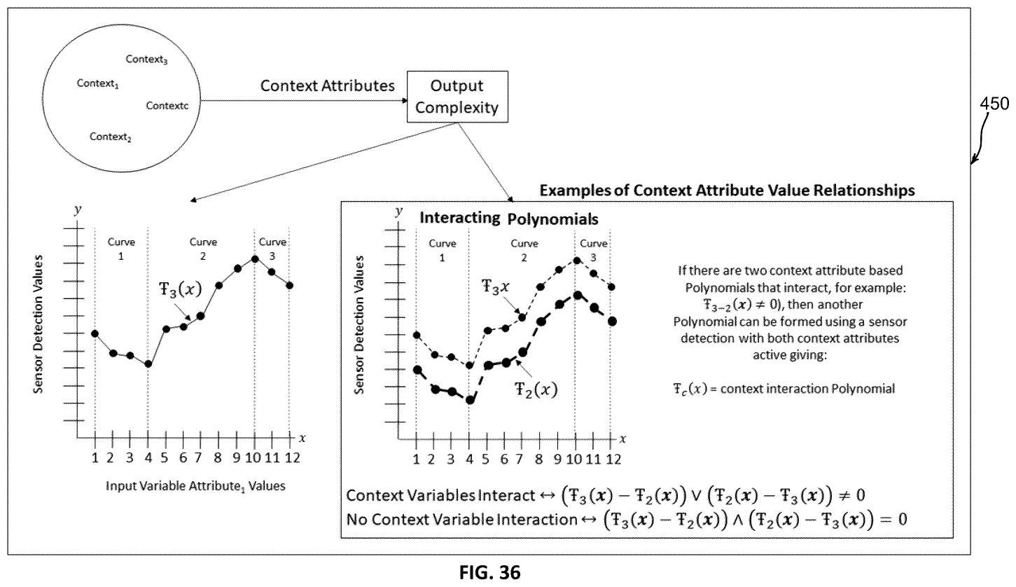

FIG. 36 depicts a diagram 450 showing it is possible for the effects of one context variable to be fully or partially cancelled by the effects of another context variable. This could have the effect of seemingly random detection changes. The effects of one context variable on another are graphed here. To determine the interaction of multiple context variables, the difference between two context output complexities found using sensor readings is determined.

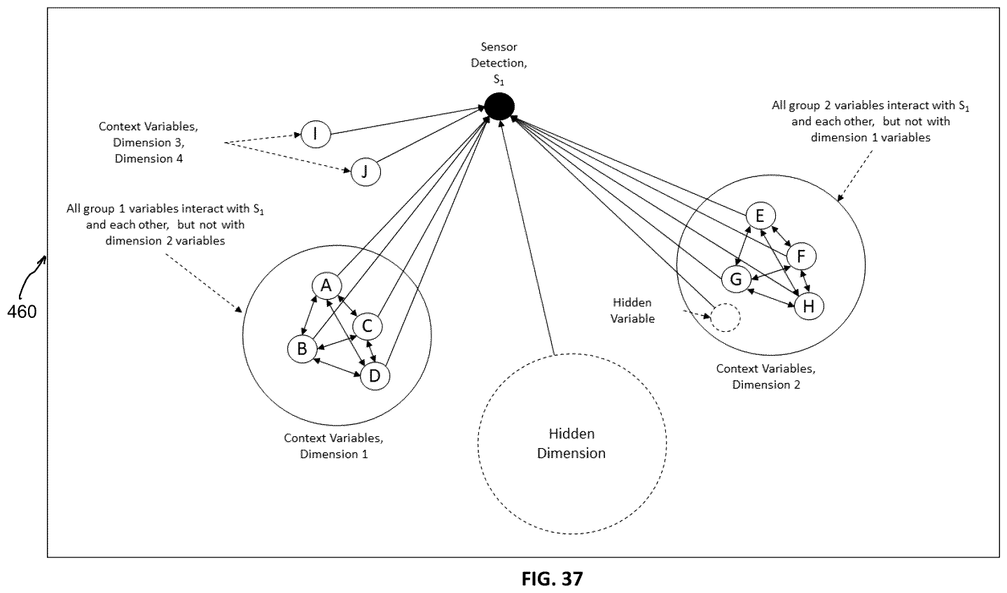

FIG. 37 depicts a diagram 460 showing two sets of context variables in which the context variables within a set additively interact with each other but the two sets do not interact with each other. Consider the standard physical dimensions of length and width. Because they are commensurable, they can be multiplied or divided but cannot be compared, added, or subtracted because they represent variables of different dimensions. Thus, the two sets here are in different dimensions. A single independent context variable associated with a sensor detection that is not additively associated can also be thought of as being on different dimension.

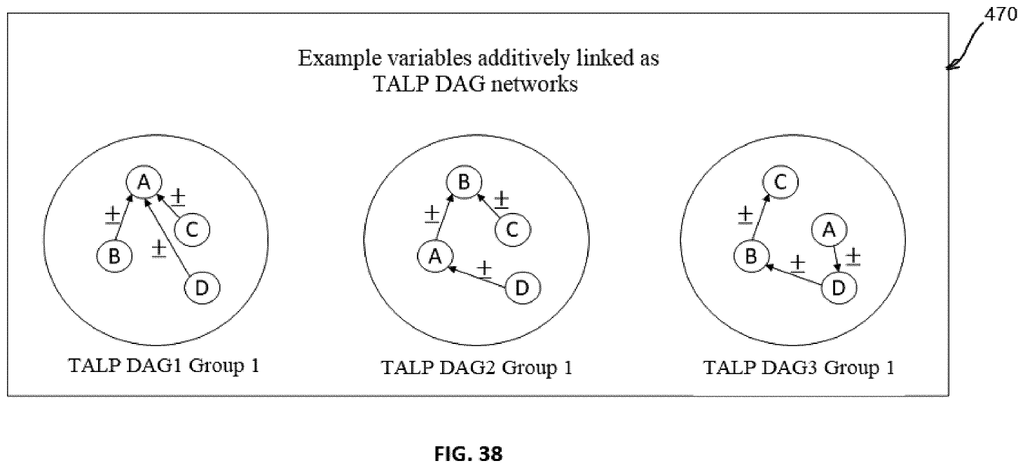

FIG. 38 depicts a diagram 470 showing that since there can be no loops with these additive relationships, a network formed of context variables connected using additive relationships is a directed acyclic graph (DAG). Sets of independent context variables connected as DAGs are herein said to define a context dimension. The effect of the DAG-connected context variables on the sensor detection can be used in the multi-variable prediction polynomial (analytics) generation method of this invention, giving in this case output complexity. If the inherent behaviors of the context variables are extracted and are within a single context dimension, then the inherent context behavior of that dimension can be predicted.

Consider that a Bayesian network selects a network node based on connecting vectors consisting of probabilities, which is the basis of generative AI. Consider further that all such networks are a subset of DAGs. If all network nodes are replaced by TALPs then the network is a TALP DAG and is suitable for use in Bayesian networks, offering an enhancement to generative AI. A network node could be a context variable and the connecting vectors could be representative of the additive relationships between the connected context variables.

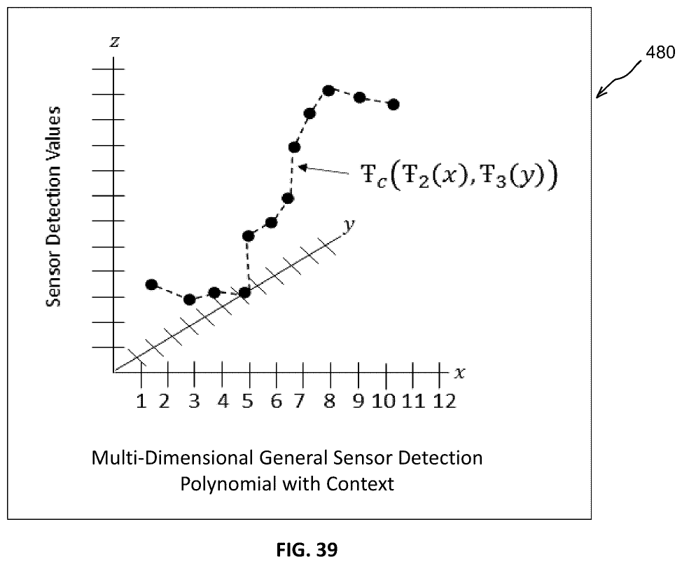

FIG. 39 depicts a graph 480 showing that since each dimension has its own generated context output complexity, a general sensor detection output complexity with multi-dimensional context can be generated.

Consider a context dimension with all independent variable values held constant. If there is variation in a computed value of the sensor output complexity, then a hidden variable is indicated for that dimension. If there are no variations in any of the context dimensions while all independent variable values are held constant, yet there is variation in the sensor detection when repeatedly attempting to detect the same item under the same conditions, then a hidden context dimension is indicated.

Thus, it is possible to hypothesize the existence of context effects on sensor data and test that hypothesis. It is also possible to hypothesize hidden context variables and context dimensions.

Various embodiments, concepts, systems, and aspects of the present invention can include a software method of determining sensitivity of a prediction polynomial of a TALP of an algorithm or source code, comprising determining the sensitivity of an advanced time complexity of the TALP of the algorithm or source code by comparing associated OALP time prediction polynomials to each other, wherein an input variable attribute of the OALP with a largest time prediction polynomial is considered most sensitive; determining the sensitivity of an advanced space complexity of the TALP of the algorithm or source code by comparing associated OALP space prediction polynomials to each other, wherein the input variable attribute of the OALP with a largest space prediction polynomial is considered most sensitive; and determining the sensitivity of an output complexity of the TALP of the algorithm or source code by comparing associated OALP output prediction polynomials to each other, wherein the input variable attribute of the OALP with a largest output prediction polynomial is considered most sensitive.

In various embodiments, the input variable attribute with a smallest time prediction or space prediction or output prediction polynomial is considered least sensitive.

In various embodiments, the sensitivity of the advanced time complexity or advanced space complexity or output complexity of the TALP of the algorithm or source code is an effect of the input variable attribute on an output variable attribute affecting time or space or output values.

In various embodiments, the effect is determined by varying a single input variable value at a time while holding other input variable values constant, which is automatic when using OALPs since each OALP has a single input variable attribute.

In various embodiments, the method further comprises determining an importance of the input variable attribute to the TALP of the algorithm or source code.

In various embodiments, the OALP represents a set of irreducible overlaid pathways, each with a single input variable attribute and one or more output variable attributes.

Various embodiments, concepts, systems, and aspects of the present invention can include a software method of determining when non-linear graph curves can interact as if linear using a shape of the non-linear graph curves as determined by a comparison of base T-polynomials extracted from associated prediction polynomials or T-polynomials, comprising: extracting one or more base T-polynomials from one or more T-polynomials, or from one or more predictive polynomials of a TALP of an algorithm or source code, or from an OALP, by removing size and position variables; comparing the one or more base T-polynomials of the TALP of the algorithm or source code, or the OALP, to determine polynomial equality; determining if the one or more base T-polynomials of the TALP or OALP are equal; determining TALP line segments from data of graph curves for all TALPs or OALPs whose one or more base T-polynomials are equal; forming TALP surfaces, TALP volumes, or TALP vectors from one or more linked TALP line segments; and forming one or more TALP directed acyclic graphs (TALP DAGs) from one or more networks including TALP nodes.

In various embodiments, the one or more networks comprise linked context variables, and one or more connecting vectors are representative of an additive relationship between connected context variables.

In various embodiments, the one or more prediction polynomials are formed from a predictable aspect of the TALP of the algorithm or source code represented by the one or more graphs.

In various embodiments, the predictable aspect of the algorithm or source code is an inherent analytic for the TALP of the algorithm or source code.

In various embodiments, the method further comprises determining prediction polynomials from one or more base T-polynomials by multiplying the one or more base T-polynomials by a smallest detected value used when generating the base T-polynomials.

In various embodiments, the one or more base T-polynomials are converted into the one or more prediction polynomials to define an analytic automatically generated from data extracted from the TALP or the OALP.

In various embodiments, when all of the one or more base T-polynomials of the TALP or the OALP give a same value, then the TALP or OALP is defined as perfect, and when all of the one or more base T-polynomials of the TALP or the OALP give a same value, then a class of the TALP or OALP are defined as perfect.

In various embodiments, the TALP or OALP are executed on multiple processing elements.

In various embodiments, when the TALP or OALP are executed on the multiple processing elements, an amount of consumed power for processing the TALP or OALP is defined.

Various embodiments, concepts, systems, and aspects of the present invention can include a software method of generating analytics for TALPs, comprising: creating an extended target values table containing derivatives of each header term used to simultaneously generate scaled polynomials and their associated scaled derivative polynomials for a single TALP set of input dataset attribute values for a single TALP input dataset attribute; decomposing the TALP into one or more OALPs, each with a single active input variable attribute with all other attributes held constant, retaining the mathematical relationships between the OALPs; scaling (using the minimum values detected), ordering, and storing simultaneously for each OALP a table called the source values table with the input dataset attribute values from smallest to largest (ascending), reversing any received input dataset attribute values that are largest to smallest (descending) while retaining an indication of a reversal; comparing one or more source values table values to the associated values of the target values table; creating a scaled polynomial called a T-polynomial and its derivatives, first, second, third (and the like) derivative T-polynomials based on the comparison for each OALP, the input to output data signs indicating the graph quadrant and any reversal; and generating predictive polynomials (analytics) for each OALP by multiplying the OALP's T-polynomial and its derivative T-polynomials by their respective smallest value found in the respective OALP's source value table value.

Various embodiments, concepts, systems, and aspects of the present invention can include a software method of determining the meaning of various analytics from TALPs depending on the origin of source values table values, comprising: relating scaled ascending or descending input variable attributes that affect loop iterations to variable scaled processing time to get the T-polynomial speedup (giving the decrease in processing time per processing element), its inverse T-polynomial ispeedup (giving the scaled temporal input variable attribute value that is equivalent to the number of processing elements), speedup's first derivative T-polynomial (giving speedup instantaneous velocity), and speedup's second derivative T-polynomial (giving speedup instantaneous acceleration); unscaling the advanced speedup T-polynomial to get the advanced time complexity prediction polynomial time (giving processing time), the inverse advanced time complexity prediction polynomial itime (giving the temporal input variable attribute values), time's first derivative prediction polynomial (giving processing velocity), and time's second derivative prediction polynomial (giving processing acceleration); relating scaled ascending or descending input variable attributes that affect memory allocation to a scaled processing space to get the T-polynomial freeup (giving the decrease in required processing space per processing element), its inverse T-polynomial, ifreeup (giving the scaled spatial input variable attribute value which is equivalent to the number of processing elements), freeup's first derivative T-polynomial (giving freeup instantaneous velocity), and freeup's second derivative T-polynomial (giving freeup instantaneous acceleration); unscaling the freeup T-polynomial to get the advanced space complexity prediction polynomial space (giving memory allocation), the inverse advance space complexity prediction polynomial ispace (giving the spatial input variable attribute values), space's first derivative prediction polynomial (giving spatial change velocity), space's second derivative prediction polynomial (giving spatial change acceleration); relating scaled ascending or descending input variable attributes that affect output to a scaled outputs to get the T-polynomial divvyup (giving the decrease in output values per processing element), its inverse T-polynomial idivvyup (giving the scaled output-affecting input variable attribute value which is equivalent to the number of processing elements), divvyup's first derivative T-polynomial (giving divvyup instantaneous velocity), and divvyup's second derivative T-polynomial (giving divvyup instantaneous acceleration); and unscaling the divvyup T-polynomial to get the output complexity prediction polynomial output (giving the output values), the inverse output complexity prediction polynomial ioutput (giving the output-affecting input variable attribute values), output's first derivative prediction polynomial (giving output change velocity), output's second derivative prediction polynomial (giving output change acceleration).

In various embodiments, known non-linear curve-fitting methods that used table searches rather than calculations to build polynomials are expanded to include:

A. The first and second derivatives of each term.

B. The automatic expansion of the search table itself based on maximum error calculations.

C. The retention of table-generated polynomials (herein called T-polynomials) for future use.

D. The data points that the method can perform a curve fit on have been expanded from first quadrant ascending curves only to descending as well as ascending data points in any Cartesian graph quadrant.

In various embodiments, T-polynomials are expanded to base T-polynomials (the shape of a curve without size and position) that are used to define when the interaction of high-order polynomials can be treated as if they were linear functions as well as to define TALP surfaces and volumes.

In various embodiments, the number of inherent analytics that are extractable from the TALPs of an algorithm or source code is expanded to include:

A. Advanced time complexity—time prediction from temporal input variable attribute values, extended to include ascending and descending curves.
a. Advanced speedup—scaled advanced time complexity, predicted processing time performance multiplier from the number of processing elements.
b. Inverse advanced time complexity—predicted temporal input variable attribute values from time.
c. Inverse advanced speedup—predicted number of processing elements from the processing time performance multiplier.

B. Type I, II, and III advanced space complexity—memory allocation prediction from input variable attribute values, including ascending and descending curves.
a. Freeup—scaled advanced space complexity, predicted memory allocation divisor given the number of processing elements.
b. Inverse advanced space complexity—predicted input variable attribute values from memory allocation.
c. Inverse freeup—predicted number of processing elements from the memory allocation divisor.

C. Resource complexity—an extension of space complexity that predicts the allocation of non-memory hardware for an algorithm (e.g., display screens, communication channels, etc.).

D. Output complexity—output variable attribute value predictions from input variable attribute values that affect output.
a. Divvyup—scaled output complexity, predicted output value divisor given the number of processing elements.
b. Inverse output complexity—predicted input variable attribute values from computed ouput values.
c. Inverse divvyup—predicted number of processing elements from the output value divisor.

In various embodiments, an overlay to the TALP execution pathway is defined herein, the OALP, allowing for input variable sensitivity analysis and multi-variable T-polynomial generation from which predictive polynomials are created.

In various embodiments, TALP directed acyclic graphs (TALP DAGs) are used for the automatic detection and quantification of context variables, and their dimensionality using TALPs for more accurate sensor analysis. TALP DAGs allow for TALP incorporation into generative AI.

It will be recognized by one skilled in the art that operations, functions, algorithms, logic, method steps, routines, sub-routines, and modules may be implemented in software, in firmware, in special purpose digital logic, and any combination thereof without deviating from the spirit and scope of the present invention as recited within the claims attached hereto.

The present invention may be embodied in other specific forms without departing from the spirit or essential attributes thereof, and it is, therefore, desired that the present embodiment be considered in all respects as illustrative and not restrictive. Similarly, the above-described methods, steps, apparatuses, and techniques for providing and using the present invention are illustrative processes and are not intended to be limited to those specifically defined herein. Further, features and aspects, in whole or in part, of the various embodiments described herein can be combined to form additional embodiments within the scope of the invention even if such combination is not specifically described herein.

For purposes of interpreting the claims for the present invention, it is expressly intended that the provisions of Section 112(f) of 35 U.S.C. are not to be invoked unless the specific terms “means for” or “step for” are recited in a claim.

What is claimed is:

1. A software method of determining sensitivity of a prediction polynomial of a time-affecting linear pathway (TALP) of an algorithm or source code, comprising:
determining the sensitivity of an advanced time complexity of the TALP of the algorithm or source code by comparing associated output-affecting linear pathway (OALP) time prediction polynomials to each other, wherein an input variable attribute of the OALP with a largest time prediction polynomial is considered most sensitive;
determining the sensitivity of an advanced space complexity of the TALP of the algorithm or source code by comparing associated OALP space prediction polynomials to each other, wherein the input variable attribute of the OALP with a largest space prediction polynomial is considered most sensitive; and
determining the sensitivity of an output complexity of the TALP of the algorithm or source code by comparing associated OALP output prediction polynomials to each other, wherein the input variable attribute of the OALP with a largest output prediction polynomial is considered most sensitive.

2. The method of claim 1, wherein the input variable attribute with a smallest time prediction or space prediction or output prediction polynomial is considered least sensitive.

3. The method of claim 1, wherein the sensitivity of the advanced time complexity or advanced space complexity or output complexity of the TALP of the algorithm or source code is an effect of the input variable attribute on an output variable attribute affecting time or space or output values.

4. The method of claim 3, wherein the effect is determined by varying a single input variable value at a time while holding other input variable values constant, which is automatic when using OALPs since each OALP has a single input variable attribute.

5. The method of claim 4, further comprising determining an importance of the input variable attribute to the TALP of the algorithm or source code.

6. The method of claim 1, wherein the OALP represents a set of irreducible overlaid pathways, each with a single input variable attribute and one or more output variable attributes.

7. A software method of determining when non-linear graph curves can interact as if linear using a shape of the non-linear graph curves as determined by a comparison of base T-polynomials extracted from associated prediction polynomials or T-polynomials, comprising:
extracting one or more base T-polynomials from one or more T-polynomials, or from one or more predictive polynomials of a time-affecting linear pathway (TALP) of an algorithm or source code, or from an output-affecting linear pathway (OALP), by removing size and position variables;
comparing the one or more base T-polynomials of the TALP of the algorithm or source code, or the OALP, to determine polynomial equality;
determining if the one or more base T-polynomials of the TALP or OALP are equal;
determining TALP line segments from data of graph curves for all TALPs or OALPs whose one or more base T-polynomials are equal;
forming TALP surfaces, TALP volumes, or TALP vectors from one or more linked TALP line segments; and
forming one or more TALP directed acyclic graphs (TALP DAGs) from one or more networks including TALP nodes.

8. The method of claim 7, wherein the one or more networks comprise linked context variables, and one or more connecting vectors are representative of an additive relationship between connected context variables.

9. The method of claim 7, wherein the one or more prediction polynomials are formed from a predictable aspect of the TALP of the algorithm or source code represented by the one or more graphs.

10. The method of claim 9, wherein the predictable aspect of the algorithm or source code is an inherent analytic for the TALP of the algorithm or source code.

11. The method of claim 7, further comprising determining prediction polynomials from one or more base T-polynomials by multiplying the one or more base T-polynomials by a smallest detected value used when generating the base T-polynomials.

12. The method of claim 7, wherein the one or more base T-polynomials are converted into the one or more prediction polynomials to define an analytic automatically generated from data extracted from the TALP or the OALP.

13. The method of claim 7, wherein when all of the one or more base T-polynomials of the TALP or the OALP give a same value, then the TALP or OALP is defined as perfect, and when all of the one or more base T-polynomials of the TALP or the OALP give a same value, then a class of the TALP or OALP are defined as perfect.

14. The method of claim 7, wherein the TALP or OALP are executed on multiple processing elements.

15. The method of claim 14, wherein when the TALP or OALP are executed on the multiple processing elements, an amount of consumed power for processing the TALP or OALP is defined.

16. A software system of determining sensitivity of a prediction polynomial of a time-affecting linear pathway (TALP) of an algorithm or source code, comprising:
a memory; and
a processor operatively coupled to the memory, wherein the processor is configured to execute program code to:
determine the sensitivity of an advanced time complexity of the TALP of the algorithm or source code by comparing associated output-affecting linear pathway (OALP) time prediction polynomials to each other, wherein an input variable attribute of the OALP with a largest time prediction polynomial is considered most sensitive;
determine the sensitivity of an advanced space complexity of the TALP of the algorithm or source code by comparing associated OALP space prediction polynomials to each other, wherein the input variable attribute of the OALP with the largest space prediction polynomial is considered most sensitive; and
determine the sensitivity of an output complexity of the TALP of the algorithm or source code by comparing associated OALP output prediction polynomials to each other, wherein the input variable attribute of the OALP with the largest output prediction polynomial is considered most sensitive.

17. The system of claim 16, wherein the input variable attribute with a smallest time prediction or space prediction or output prediction polynomial is considered least sensitive.

18. The system of claim 16, wherein the sensitivity of the advanced time complexity or advanced space complexity or output complexity of the TALP of the algorithm or source code is an effect of the input variable attribute on an output variable attribute affecting time or space or output values, and wherein the effect is determined by varying a single input variable value at a time while holding other input variable values constant, which is automatic when using OALPs since each OALP has a single input variable attribute.

19. The system of claim 18, further comprising determining an importance of the input variable attribute to the TALP of the algorithm or source code.

20. The system of claim 16, wherein the OALP represents a set of irreducible overlaid pathways, each with a single input variable attribute and one or more output variable attributes.
